(19) United States
(12) Patent Application Publication
(10) Pub. No.: US 2026/0113720 A1
(43) Pub. Date: Apr. 23, 2026

(54) SIDELINK SYNCHRONIZATION SIGNALING

(71) Applicant: QUALCOMM Incorporated, San Diego, CA (US)

(72) Inventors: Sourjya DUTTA, Jersey City, NJ (US); Kapil GULATI, Belle Mead, NJ (US); Navid ABEDINI, Basking Ridge, NJ (US)

(21) Appl. No.: 18/922,260

(22) Filed: Oct. 21, 2024

(51) Int. Cl. H04W 56/00; H04W 52/02; H04W 72/25; H04W 76/28; H04W 92/18

(52) U.S. Cl. CPC H04W 56/0015; H04W 52/0261; H04W 72/25; H04W 76/28; H04W 92/18

(57) ABSTRACT

In some examples of the techniques described herein, one or more user equipments (UEs) may conserve power by reducing communication during one or more sidelink synchronization signal block (S-SSB) resources. In some aspects, sidelink UEs may be capable of performing enhanced power savings by deactivating transmission or reception of sidelink SSB signals when in a sidelink discontinuous reception (SL DRX) state or mode. In some approaches, if a sidelink UE is a synchronization source, relatively higher power may be drawn during the DRX period to transmit S-SSB and a physical broadcast shared channel (PBSCH). Deactivating the S-SSB transmission or reducing S-SSB reception when in a power saving mode may significantly reduce UE power consumption. To skip reception of one or more S-SSBs or enter into a relatively long DRX period, a UE may coordinate with one or more peer devices.

### FIELD OF TECHNOLOGY

The following relates to wireless communications, including sidelink synchronization signaling.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a first user equipment (UE) is described. The method may include transmitting a first sidelink synchronization signal block (S-SSB) from the first UE as a first synchronization source, where the first S-SSB includes a first sidelink synchronization signal (SL-SS) identifier and transmitting a second S-SSB, where the second S-SSB includes a second SL-SS identifier indicating a discontinuation of S-SSB transmission by the first UE.

A first UE for wireless communications is described. The first UE may include one or more memories storing processor executable code, and one or more processors coupled with the one or more memories. The one or more processors may individually or collectively be operable to execute the code to cause the first UE to transmit a first S-SSB from the first UE as a first synchronization source, where the first S-SSB includes a first SL-SS identifier and transmit a second S-SSB, where the second S-SSB includes a second SL-SS identifier indicating a discontinuation of S-SSB transmission by the first UE.

Another first UE for wireless communications is described. The first UE may include means for transmitting a first S-SSB from the first UE as a first synchronization source, where the first S-SSB includes a first SL-SS identifier and means for transmitting a second S-SSB, where the second S-SSB includes a second SL-SS identifier indicating a discontinuation of S-SSB transmission by the first UE.

A non-transitory computer-readable medium storing code for wireless communications is described. The code may include instructions executable by one or more processors to transmit a first S-SSB from the first UE as a first synchronization source, where the first S-SSB includes a first SL-SS identifier and transmit a second S-SSB, where the second S-SSB includes a second SL-SS identifier indicating a discontinuation of S-SSB transmission by the first UE.

Some examples of the method, first UEs, and non-transitory computer-readable medium described herein may further include operations, features, means, or instructions for receiving configuration information indicating the second SL-SS identifier for indicating the discontinuation of S-SSB transmission by the first UE.

In some examples of the method, first UEs, and non-transitory computer-readable medium described herein, the second SL-SS identifier for indicating the discontinuation of S-SSB transmission by the first UE may be selected from a set of SL-SS identifiers.

In some examples of the method, first UEs, and non-transitory computer-readable medium described herein, the second SL-SS identifier for indicating the discontinuation of S-SSB transmission by the first UE may be based on the first SL-SS identifier associated with the first S-SSB from the first UE as the first synchronization source.

In some examples of the method, first UEs, and non-transitory computer-readable medium described herein, the second SL-SS identifier for indicating the discontinuation of S-SSB transmission by the first UE may be based on a combination of the first SL-SS identifier and a static value.

In some examples of the method, first UEs, and non-transitory computer-readable medium described herein, the second S-SSB including the second SL-SS identifier for indicating the discontinuation of S-SSB transmission by the first UE may be transmitted on a same resource in a frequency domain as the first S-SSB.

Some examples of the method, first UEs, and non-transitory computer-readable medium described herein may further include operations, features, means, or instructions for entering a sidelink discontinuous reception (SL discontinuous reception (DRX)) state associated with the discontinuation of S-SSB transmission by the first UE and entering an awake state after the SL DRX state, where the first UE synchronizes with another UE based on another S-SSB or resumes S-SSB transmission based on an S-SSB unavailability.

In some examples of the method, first UEs, and non-transitory computer-readable medium described herein, the first S-SSB may be associated with a first power conservation regime that consumes less power than a second power conservation regime and the second S-SSB including the second SL-SS identifier indicating the discontinuation of S-SSB transmission by the first UE may be associated with the first power conservation regime.

Some examples of the method, first UEs, and non-transitory computer-readable medium described herein may further include operations, features, means, or instructions for resuming the S-SSB transmission associated with the first power conservation regime after the discontinuation of S-SSB transmission by the first UE.

Some examples of the method, first UEs, and non-transitory computer-readable medium described herein may further include operations, features, means, or instructions for receiving a third S-SSB from a second synchronization source after the discontinuation of S-SSB transmission by the first UE.

A method for wireless communications by a second UE is described. The method may include receiving a first S-SSB from a first UE as a first synchronization source, where the first S-SSB includes a first SL-SS identifier and receiving a second S-SSB, where the second S-SSB includes a second SL-SS identifier indicating a discontinuation of S-SSB transmission by the first UE.

A second UE for wireless communications is described. The second UE may include one or more memories storing processor executable code, and one or more processors coupled with the one or more memories. The one or more processors may individually or collectively be operable to execute the code to cause the second UE to receive a first S-SSB from a first UE as a first synchronization source, where the first S-SSB includes a first SL-SS identifier and receive a second S-SSB, where the second S-SSB includes a second SL-SS identifier indicating a discontinuation of S-SSB transmission by the first UE.

Another second UE for wireless communications is described. The second UE may include means for receiving a first S-SSB from a first UE as a first synchronization source, where the first S-SSB includes a first SL-SS identifier and means for receiving a second S-SSB, where the second S-SSB includes a second SL-SS identifier indicating a discontinuation of S-SSB transmission by the first UE.

A non-transitory computer-readable medium storing code for wireless communications is described. The code may include instructions executable by one or more processors to receive a first S-SSB from a first UE as a first synchronization source, where the first S-SSB includes a first SL-SS identifier and receive a second S-SSB, where the second S-SSB includes a second SL-SS identifier indicating a discontinuation of S-SSB transmission by the first UE.

Some examples of the method, second UEs, and non-transitory computer-readable medium described herein may further include operations, features, means, or instructions for participating in communication of a third S-SSB from a second synchronization source after the discontinuation of S-SSB transmission by the first UE.

Some examples of the method, second UEs, and non-transitory computer-readable medium described herein may further include operations, features, means, or instructions for participating in the communication of the third S-SSB includes receiving the third S-SSB from the second synchronization source or transmitting the third S-SSB from the second UE as the second synchronization source based on an S-SSB unavailability.

In some examples of the method, second UEs, and non-transitory computer-readable medium described herein, the third S-SSB may be received with the first SL-SS identifier based on a reception, in an occasion, of the first S-SSB including the first SL-SS identifier and the second S-SSB including the second S-SSB.

A method for wireless communications by a first UE is described. The method may include receiving, from a second UE, an indication of a second S-SSB reception schedule with reduced S-SSB communication relative to a first S-SSB reception schedule and transmitting a second S-SSB including a second SL-SS identifier associated with the second S-SSB reception schedule, where the second SL-SS identifier is different from a first SL-SS identifier associated with the first S-SSB reception schedule.

A first UE for wireless communications is described. The first UE may include one or more memories storing processor executable code, and one or more processors coupled with the one or more memories. The one or more processors may individually or collectively be operable to execute the code to cause the first UE to receive, from a second UE, an indication of a second S-SSB reception schedule with reduced S-SSB communication relative to a first S-SSB reception schedule and transmit a second S-SSB including a second SL-SS identifier associated with the second S-SSB reception schedule, where the second SL-SS identifier is different from a first SL-SS identifier associated with the first S-SSB reception schedule.

Another first UE for wireless communications is described. The first UE may include means for receiving, from a second UE, an indication of a second S-SSB reception schedule with reduced S-SSB communication relative to a first S-SSB reception schedule and means for transmitting a second S-SSB including a second SL-SS identifier associated with the second S-SSB reception schedule, where the second SL-SS identifier is different from a first SL-SS identifier associated with the first S-SSB reception schedule.

A non-transitory computer-readable medium storing code for wireless communications is described. The code may include instructions executable by one or more processors to receive, from a second UE, an indication of a second S-SSB reception schedule with reduced S-SSB communication relative to a first S-SSB reception schedule and transmit a second S-SSB including a second SL-SS identifier associated with the second S-SSB reception schedule, where the second SL-SS identifier is different from a first SL-SS identifier associated with the first S-SSB reception schedule.

Some examples of the method, first UEs, and non-transitory computer-readable medium described herein may further include operations, features, means, or instructions for transmitting, after the second S-SSB, sidelink paging sidelink control information (SCI) in a slot that may be not included in the second S-SSB reception schedule, where the SCI indicates data to be transmitted to the second UE.

In some examples of the method, first UEs, and non-transitory computer-readable medium described herein, the indication of the second S-SSB reception schedule indicates a reduced periodicity relative to a periodicity of the first S-SSB reception schedule or indicates a time-division duplexing (TDD) pattern.

Some examples of the method, first UEs, and non-transitory computer-readable medium described herein may further include operations, features, means, or instructions for transmitting an indication of a third S-SSB reception schedule, where the third S-SSB reception schedule may be based on predicted data traffic for the second UE.

A method for wireless communications by a second UE is described. The method may include transmitting, to a first UE, an indication of a second S-SSB reception schedule with reduced S-SSB communication relative to a first S-SSB reception schedule and receiving a second S-SSB including a second SL-SS identifier associated with the second S-SSB reception schedule, where the second SL-SS identifier is different from a first SL-SS identifier associated with the first S-SSB reception schedule.

A second UE for wireless communications is described. The second UE may include one or more memories storing processor executable code, and one or more processors coupled with the one or more memories. The one or more processors may individually or collectively be operable to execute the code to cause the second UE to transmit, to a first UE, an indication of a second S-SSB reception schedule with reduced S-SSB communication relative to a first S-SSB reception schedule and receive a second S-SSB including a second SL-SS identifier associated with the second S-SSB reception schedule, where the second SL-SS identifier is different from a first SL-SS identifier associated with the first S-SSB reception schedule.

Another second UE for wireless communications is described. The second UE may include means for transmitting, to a first UE, an indication of a second S-SSB reception schedule with reduced S-SSB communication relative to a first S-SSB reception schedule and means for receiving a second S-SSB including a second SL-SS identifier associated with the second S-SSB reception schedule, where the second SL-SS identifier is different from a first SL-SS identifier associated with the first S-SSB reception schedule.

A non-transitory computer-readable medium storing code for wireless communications is described. The code may include instructions executable by one or more processors to transmit, to a first UE, an indication of a second S-SSB reception schedule with reduced S-SSB communication relative to a first S-SSB reception schedule and receive a second S-SSB including a second SL-SS identifier associated with the second S-SSB reception schedule, where the second SL-SS identifier is different from a first SL-SS identifier associated with the first S-SSB reception schedule.

Some examples of the method, second UEs, and non-transitory computer-readable medium described herein may further include operations, features, means, or instructions for receiving, after the second S-SSB, sidelink paging SCI in a slot that may be not included in the second S-SSB reception schedule, where the SCI indicates data to be transmitted to the second UE.

In some examples of the method, second UEs, and non-transitory computer-readable medium described herein, the indication of the second S-SSB reception schedule indicates a reduced periodicity relative to a periodicity of the first S-SSB reception schedule or indicates a TDD pattern.

In some examples of the method, second UEs, and non-transitory computer-readable medium described herein, the indication of the second S-SSB reception schedule may be communicated via one or more radio resource control (RRC) messages or via one or more media access control-control element (MAC-CE) messages via a sidelink.

In some examples of the method, second UEs, and non-transitory computer-readable medium described herein, resources of the second S-SSB reception schedule may be associated with one or more spatial filters and the one or more spatial filters may be quasi-co-located with one or more transmit beams of the first UE.

Some examples of the method, second UEs, and non-transitory computer-readable medium described herein may further include operations, features, means, or instructions for receiving an indication of a third S-SSB reception schedule, where the third S-SSB reception schedule may be based on predicted data traffic for the second UE.

Some examples of the method, second UEs, and non-transitory computer-readable medium described herein may further include operations, features, means, or instructions for receiving an indication of a reception pattern, where the second UE activates a receiver for a combination of the second S-SSB reception schedule and the reception pattern.

Some examples of the method, second UEs, and non-transitory computer-readable medium described herein may further include operations, features, means, or instructions for receiving an indication rejecting the second S-SSB reception schedule and entering a DRX state in response to the indication.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports sidelink synchronization signaling in accordance with one or more aspects of the present disclosure.

FIG. 2 shows an example of a wireless communications system that supports sidelink synchronization signaling in accordance with one or more aspects of the present disclosure.

FIG. 3 shows an example of a wireless communications system that supports sidelink synchronization signaling in accordance with one or more aspects of the present disclosure.

FIG. 4 shows an example of a timing diagram that supports sidelink synchronization signaling in accordance with one or more aspects of the present disclosure.

FIG. 5 shows an example of a timing diagram that supports sidelink synchronization signaling in accordance with one or more aspects of the present disclosure.

FIG. 6 shows an example of a process flow that supports sidelink synchronization signaling in accordance with one or more aspects of the present disclosure.

FIGS. 7 and 8 show block diagrams of devices that support sidelink synchronization signaling in accordance with one or more aspects of the present disclosure.

FIG. 9 shows a block diagram of a communications manager that supports sidelink synchronization signaling in accordance with one or more aspects of the present disclosure.

FIG. 10 shows a diagram of a system including a device that supports sidelink synchronization signaling in accordance with one or more aspects of the present disclosure.

FIGS. 11 through 18 show flowcharts illustrating methods that support sidelink synchronization signaling in accordance with one or more aspects of the present disclosure.

### DETAILED DESCRIPTION

Some wireless communications systems perform sidelink communication between user equipments (UEs). Sidelink communication may be communication between devices (e.g., UEs) without an intervening network entity. In some approaches, discontinuous reception (DRX) may be utilized for sidelink transmissions, which may reduce power consumption. In DRX, a transmitter or receiver may be deactivated, but may periodically enter an active (e.g., “awake”) state to transmit or receive synchronization signals or other signaling. In sidelink DRX, a UE's sidelink control information (SCI) monitoring activity may be controlled for unicast, groupcast and broadcast communications.

Sidelink communication resources may be split into two non-overlapping resource pools, where a first resource pool may be utilized for sidelink control, data, or feedback transmissions. Sidelink DRX may be applicable to the first resource pool. The second resource pool may include resources configured for sidelink synchronization. The second resource pool may include separate slots that are time division multiplexed with the first resource pool. The second resource pool (e.g., slots) may be utilized to communicate sidelink synchronization signal blocks (S-SSBs). An S-SSB may include a sidelink primary synchronization signal (S-PSS) sequence and a sidelink secondary synchronization signal (S-SSS) sequence with a broadcast message. The S-PSS and the S-SSS may be derived based on a sidelink synchronization signal identifier determined by the synchronization source (e.g., a UE that transmits synchronization signals) based on which sidelink synchronization may be performed. In some approaches, sidelink synchronization is not impacted by the sidelink DRX. For example, a sidelink UE may save power by not decoding SCI, but the sidelink UE may still transmit or receive S-SSBs during sidelink DRX off periods for synchronization. This may ensure that sidelink UEs remain time synchronized, as a loss of synchronization may lead to relatively increased packet losses. Accordingly, even in a power savings mode, a sidelink UE may continue receiving or transmitting over sidelink SSB resources. In some examples, the sidelink SSB resources may occur 1, 2, or 4 times with a periodicity of 160 milliseconds (ms) (in frequency range 1 (FR1)) or more frequently for frequency range 2 (FR2). Accordingly, power may continue to be consumed during sidelink DRX off periods to communicate (e.g., transmit or receive) S-SSBs.

In some examples of the techniques described herein, one or more UEs may conserve power by reducing communication during one or more S-SSB resources (when configured with a sidelink DRX (SL DRX) mode, for instance). In some aspects, sidelink UEs may be capable of performing enhanced power savings by deactivating transmission or reception of sidelink SSB signals when in SL DRX mode. For instance, activating the radio receiver to receive an S-SSB every 80 ms may consume more power than receiving periodic traffic in 100 ms or 200 ms cycles (e.g., in sidelink periodicities). In some approaches, if a sidelink UE is a synchronization source, relatively higher power may be drawn during the DRX period to transmit S-SSB and a physical broadcast shared channel (PBSCH). Deactivating the S-SSB transmission or reducing S-SSB reception when in a power saving mode may significantly reduce UE power consumption. Some approaches may be relevant for low power Internet of things (IoT) devices in a sub-6 gigahertz (GHz) frequency range or may be relevant to general sidelink use cases for higher bands when S-SSBs are more frequent (e.g., in FR2). Skipping one or more S-SSB transmissions by a UE may impact one or more peer devices (with which the UE has data links), or may impact one or more sidelink UEs in the system that derive synchronization from the UE. To skip reception of one or more S-SSBs or enter into a relatively long DRX period, a UE may coordinate with one or more peer devices (e.g., sidelink UEs) to enable synchronization before active (e.g., “on”) periods or may receive early paging indications on the sidelink in some cases.

Aspects of the disclosure are initially described in the context of wireless communications systems. Aspects of the disclosure are also described in the context of timing diagrams and a process flow. Aspects of the disclosure are further illustrated by and described with reference to apparatus diagrams, system diagrams, and flowcharts that relate to sidelink synchronization signaling.

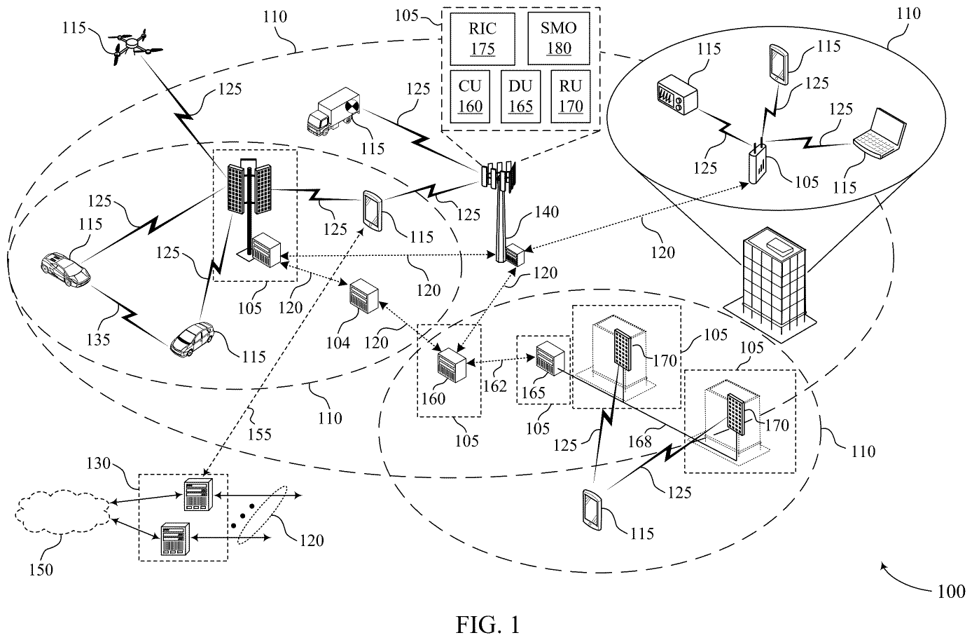

FIG. 1 shows an example of a wireless communications system 100 that supports sidelink synchronization signaling in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support sidelink synchronization signaling as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 GHz. Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHZ, also known as the centimeter band, or using an extremely high frequency (EHF) region of the spectrum (e.g., from 30 GHz to 300 GHZ), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Some wireless communications systems perform sidelink communication between UEs 115. Sidelink communication may be communication between devices (e.g., UEs 115) without an intervening network entity 105. In some approaches, DRX may be utilized for sidelink transmissions, which may reduce power consumption. In DRX, a transmitter or receiver may be deactivated, but may periodically enter an active (e.g., “awake”) state to transmit or receive synchronization signals or other signaling. In sidelink DRX, a UE's SCI monitoring activity may be controlled for unicast, groupcast and broadcast communications.

Sidelink communication resources may be split into two non-overlapping resource pools, where a first resource pool may be utilized for sidelink control, data, or feedback transmissions. Sidelink DRX may be applicable to the first resource pool. The second resource pool may include resources configured for sidelink synchronization. The second resource pool may include separate slots that are time division multiplexed with the first resource pool. The second resource pool (e.g., slots) may be utilized to communicate S-SSBs. An S-SSB may include an S-PSS sequence and an S-SSS sequence with a broadcast message. The S-PSS and the S-SSS may be derived based on a sidelink synchronization signal identifier determined by the synchronization source (e.g., a UE 115 that may transmit a synchronization signal(s), a base station that may transmit a synchronization signal(s), or a global navigation satellite system (GNSS) that may transmit a synchronization signal(s)) based on which sidelink synchronization may be performed (e.g., based on which sidelink synchronization may be performed at the UE transmitting the S-PSS and S-SSS signals). In some approaches, sidelink synchronization is not impacted by the sidelink DRX. For example, a sidelink UE may save power by not decoding SCI, but the sidelink UE may still transmit or receive S-SSBs during sidelink DRX off periods for synchronization. This may ensure that sidelink UEs remain time synchronized, as a loss of synchronization may lead to relatively increased packet losses. Accordingly, even in a power savings mode, a sidelink UE may continue receiving or transmitting over sidelink SSB resources. The sidelink SSB resources may occur 1, 2, or 4 times in a periodicity of 160 ms (in FR1) or more frequently (for FR2). Accordingly, power may continue to be consumed during sidelink DRX off periods to communicate (e.g., transmit or receive) S-SSBs.

In some examples of the techniques described herein, one or more UEs 115 may conserve power by reducing communication during one or more S-SSB resources (when configured with an SL DRX mode, for instance). In some aspects, sidelink UEs 115 may be capable of performing enhanced power savings by deactivating transmission or reception of sidelink SSB signals when in SL DRX mode. For instance, activating the radio receiver to receive an S-SSB with a periodicity of 80 ms may consume more power than receiving periodic traffic in 100 ms or 200 ms cycles (e.g., in sidelink periodicities). In some approaches, if a sidelink UE 115 is a synchronization source, relatively higher power may be drawn during the DRX period to transmit S-SSB and a PBSCH. Deactivating the S-SSB transmission or reducing S-SSB reception when in a power saving mode may significantly reduce UE 115 power consumption. Some approaches may be relevant for low power IoT devices in a sub-6 GHz frequency range or may be relevant to general sidelink use cases for higher bands when S-SSBs are more frequent due to a demand to beamform (e.g., in FR2). Skipping one or more S-SSB transmissions by a UE 115 may impact one or more peer devices (with which the UE 115 has data links), or may impact one or more sidelink UEs 115 in the system that derive synchronization from the UE 115. To skip reception of one or more S-SSBs or enter into a relatively long DRX period, a UE 115 may coordinate with one or more peer devices (e.g., sidelink UEs 115) to enable synchronization before active (e.g., “on”) periods or may receive early paging indications on the sidelink in some cases.

Some examples of the techniques described herein may include one or more approaches for reducing power consumption. In some approaches, relatively low power wake up signals (LP-WUSs) may be utilized. LP-WUSs may be applied for Uu interface or sidelink communications (where devices may operate with limited (e.g., relatively tighter) power budgets. To support LP-WUSs on a sidelink, a sidelink UE 115 may support or include one or more relatively low power wake up radios (LP-WURs). An LP-WUR may include one or more components that are separate from one or more other radios (e.g., one or more orthogonal frequency division multiplexing (OFDM) transceiver components). In some approaches, an LP-WUR with receiver functionality (and without transmitter functionality, for instance) may be supported. In some approaches, an LP-WUR with both receiver and transmitter functionality may be supported (e.g., for Mode 2 or UE 115 to UE 115 communications).

In some examples, a UE 115 with LP-WUR may enter an extended-DRX or ultra-deep sleep state. In this state, the UE 115 may monitor (e.g., “listen”) with the LP-WUR for an LP-WUS from one or more sidelink peer devices or for an LP-S-SSB from one or more sidelink LP-Sync sources. In some aspects, a separate resource pool may be utilized for sidelink LP-WUS operation. The LP-S-SSB occasions may be configured or specified to occur with a fixed periodicity (e.g., with a same periodicity as the S-SSB or some integer multiple). The LP-WUS may be transmitted on any resources, barring resources on which LP-S-SSBs are configured in some approaches.

Similar to the transmission of S-SSBs, transmissions of LP-SSBs may be a source of power draw for a sidelink UE trying to save power. One or more of the techniques (e.g., a discontinuous transmission mechanism) for sidelink LP-SSBs may help reduce power consumption for sidelink communications in conjunction with LP-WUS or LP-WUR operations, or independent of LP-WUS or LP-WUR operations.

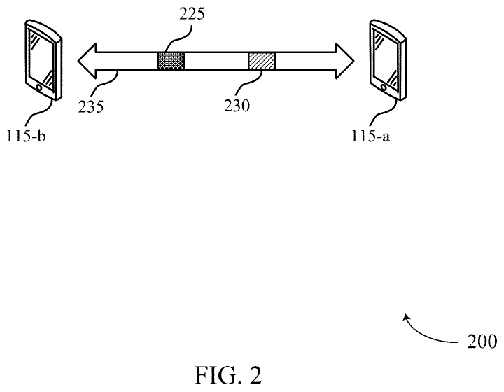

FIG. 2 shows an example of a wireless communications system 200 that supports sidelink synchronization signaling in accordance with one or more aspects of the present disclosure. The wireless communications system 200 may implement aspects of or may be implemented by aspects of the wireless communications system 100. For example, the wireless communications system 200 includes a first UE 115-a and a second UE 115-b, which may examples of the UE 115 described with reference to FIG. 1.

The first UE 115-a may communicate with the second UE 115-b via a sidelink channel 235. As used herein, the term “communicate” and variations thereof may include signal transmission, signal reception, or a combination thereof. The sidelink channel 235 may be a communication link between the first UE 115-a and the second UE 115-b (without an intervening network entity, for instance). The sidelink channel 235 may be established to provide unidirectional or bidirectional communications between the first UE 115-a and the second UE 115-b. For example, the sidelink channel 235 may carry one or more signals from the first UE 115-a to the second UE 115-b or one or more signals from the second UE 115-b to the first UE 115-a. For instance, one or more signals communicated between the first UE 115-a and the second UE 115-b may include one or more control signals or one or more data signals. In some aspects, the communication link 135 described with reference to FIG. 1 may be an example of the sidelink channel 235. Examples of the sidelink channel 235 may include a physical sidelink control channel (PSCCH), a physical sidelink shared channel (PSSCH), a physical sidelink broadcast channel (PSBCH), another channel, or any combination thereof.

The first UE 115-a may transmit a first S-SSB 225 from the first UE 115-a as a first synchronization source. The first S-SSB 225 may include a first sidelink synchronization signal (SL-SS) identifier. The second UE 115-b may receive the first S-SSB 225 including the first SL-SS identifier from the first UE 115-a. In some examples, the first SL-SS identifier may indicate that the first UE 115-a is a synchronization source (e.g., the first synchronization source), which may allow the second UE 115-b (or one or more other UEs) to utilize the first S-SSB 225 to synchronize signaling for one or more communications (with the first UE 115-a or with one or more other UEs, for instance).

The first UE 115-a may transmit a second S-SSB 230. The second S-SSB 230 may include a second SL-SS identifier indicating a discontinuation of S-SSB transmission by the first UE 115-a (e.g., indicating that the first UE 115-a is leaving the synchronization source role). The second UE 115-b may receive the second S-SSB 230, including the second SL-SS identifier indicating a discontinuation of S-SSB transmission by the first UE 115-a. For instance, the second SL-SS identifier may indicate to the second UE 115-b (or one or more other UEs) that the first UE 115-a is going to discontinue transmitting S-SSBs as a synchronization source. The second UE 115-b (or one or more other UEs) may utilize the second SL-SS identifier to trigger searching for another synchronization source or to transition to a synchronization source role. In some examples, one or more of the S-SSB communications may be performed to enhance SL DRX (e.g., to enable reduced signaling for SL DRX).

Transmitting the second S-SSB 230 may allow the first UE 115-a to discontinue S-SSB transmissions, where the first UE 115-a was acting as a synchronization source. For instance, the first UE 115-a (e.g., a sidelink UE) that is currently a synchronization source and is going to enter a reduced signaling state (e.g., SL DRX, or an ultra-deep sleep mode, among other examples) may transmit the second S-SSB 230 (e.g., an S-SSB sequence) with the second SL-SS identifier indicating that the synchronization transmission will be discontinued. Discontinuing the S-SSB transmission may enable the first UE 115-a to receive one or more S-SSBs (e.g., to only receive S-SSBs) while reducing or avoiding the transmission of S-SSBs.

Various terms may be utilized herein to denote various level of activity, which may be described in terms of states or modes. In a first state or mode (e.g., non-DRX), a UE may transmit or receive one or more signals without DRX. In a second state or mode (e.g., DRX, or default DRX), data communication occasions may be reduced by deactivating communication (e.g., transmission or reception) hardware for one or more data communication occasions. In the second state or mode (e.g., DRX or default DRX), S-SSB occasions may continue uninterrupted or a UE may monitor one or more (e.g., all) configured resources for S-SSB communication. In a third state or mode (e.g., SL DRX, enhanced SL DRX, or e-SL DRX), S-SSB communication occasions may be reduced by deactivating communication (e.g., transmission or reception) hardware for one or more S-SSB communication occasions. The third state or mode may consume fewer resources (e.g., less power, processing, or communication resources) than the second state or mode. The second state or mode may consume fewer resources (e.g., less power, processing, or communication resources) than the first state or mode. As used herein, the SL DRX state or mode may refer to the e-SL DRX state or may refer more generally to the third state or mode in some examples.

In some examples, the SL-SS identifier may be configured, specified, or randomly chosen from a configured set or specified set of SL-SS identifiers. For instance, the first UE 115-a may receive configuration information (e.g., from a network entity or another device) indicating the second SL-SS identifier for indicating the discontinuation of S-SSB transmission (by the first UE 115-a, for instance). In some aspects, the second UE 115-b (or one or more other UEs) may receive configuration information (e.g., from a network entity or another device) indicating the second SL-SS identifier for indicating the discontinuation of S-SSB transmission. Additionally, or alternatively, the second SL-SS identifier for indicating the discontinuation of S-SSB transmission by the first UE 115-a may be selected (e.g., randomly selected) from a set of SL-SS identifiers (e.g., a set of SL-SS identifiers indicating a discontinuation of S-SSB transmission). For instance, the first UE 115-a may utilize a random number generator to select the second SL-SS identifier.

In some examples, the second SL-SS identifier for indicating the discontinuation of S-SSB transmission by the first UE 115-a may be based on the first SL-SS identifier associated with the first S-SSB 225 from the first UE 115-a as the first synchronization source. For example, the second SL-SS identifier may be derived based on a function of the first SL-SS identifier. In some approaches, the second SL-SS identifier for indicating the discontinuation of S-SSB transmission by the first UE 115-a may be based on a combination of the first SL-SS identifier and a static value. For instance, the second SL-SS identifier may be derived (e.g., calculated, computed) based on the current (active state) SL-SS identifier (e.g., the first SL-SS identifier). In some aspects, the first SL-SS identifier may be denoted

$${N}_{SLSS}^{active} ,$$

the second SL-SS identifier may be denoted

$${N}_{SLSS}^{eDRX} ,$$

and the static value (e.g., an established or specified constant) may be denoted I₀. The second SL-SS identifier may be determined in accordance with Equation (1).

$${N}_{SLSS}^{eDRX} = {N}_{SLSS}^{active} + {I}_{0} \qquad ( 1 )$$

In some examples, the second S-SSB 230 that includes the second SL-SS identifier for indicating the discontinuation of S-SSB transmission by the first UE 115-a may be transmitted on a same resource in the frequency domain as the first S-SSB 225. For instance, the S-SSB with the new SL-SS identifier may be transmitted on the same S-SSB resource in the frequency domain as the previous S-SSB.

In some examples, the first UE 115-a may receive a third S-SSB from a second synchronization source after the discontinuation of S-SSB transmission by the first UE 115-a. For instance, the first UE 115-a may discontinue S-SSB transmission, while monitoring for, or receiving, a third S-SSB from a second synchronization source (e.g., the second UE 115-b or another UE).

In some approaches, the first UE 115-a may enter an SL DRX state associated with the discontinuation of S-SSB transmission by the first UE 115-a. The first UE 115-a may enter an awake state after the SL DRX state. During or after transitioning to the awake state, in some examples, the first UE 115-a may synchronize with another UE (e.g., the second UE 115-b or another UE) based on another S-SSB (e.g., another S-SSB transmitted from the second UE 115-b or another UE). During or after transitioning to the awake state, in some examples, the first UE 115-a may resume S-SSB transmission based on an S-SSB unavailability. For example, the first UE 115-a that discontinues synchronization transmission may not resume transmitting synchronization signals after waking up after the SL DRX period (if not paged during the SL DRX period, for instance). In some approaches, the first UE 115-a may first attempt to synchronize with one or more existing sources. If no synchronization source is available (e.g., only if no synchronization source is available, which may be unlikely to occur in a distributed network), the first UE 115-a may become a synchronization source based on the current timing information of the first UE 115-a.

In some examples, the first S-SSB 225 may be associated with a first power conservation regime (e.g., one or more low power operations such as DRX) that may consume less power (e.g., UE power or battery power, among other examples) than a second power conservation regime (e.g., regular operation or no DRX, among other examples). The second S-SSB 230 may include the second SL-SS identifier indicating the discontinuation of S-SSB transmission by the first UE 115-a is associated with the first power conservation regime. For instance, the first UE 115-a may be a sidelink UE that is currently transmitting an LP-S-SSB and is transitioning to a reduced power state (e.g., ultra-deep sleep). The first UE 115-a may send an SL-SS identifier (e.g., the second SL-SS identifier) on the LP-S-SSB (e.g., the second S-SSB 230) indicating discontinuation of the LP-S-SSB transmissions. As used herein, the term “power conservation regime” may refer to a category, group, or class of power conservation or power savings or one or more operations relating to power consumption or power conservation.

In some aspects, the first UE 115-a may resume the S-SSB transmission associated with the first power conservation regime after the discontinuation of S-SSB transmission by the first UE 115-a. The second UE 115-b (e.g., a sidelink UE) may derive synchronization in a reduced power state (e.g., ultra-deep sleep) based on LP-S-SSB from the first UE 115-a (e.g., a low power synchronization donor). In a case that the first UE 115-a (e.g., the low power synchronization donor) discontinues (e.g., stops) synchronization transmission, the second UE 115-b may wait for the first UE 115-a (e.g., the previous synchronization donor UE) to resume transmitting LP-S-SSBs.

In some examples, the second UE 115-b may be a recipient of the synchronization signal(s) (e.g., the first S-SSB 225 or the second S-SSB 230), and may perform one or more operations (e.g., behaviors). In some approaches, the second UE 115-b may participate in communication of a third S-SSB from a second synchronization source after the discontinuation of S-SSB transmission by the first UE 115-a. Participating in the communication of the third S-SSB may include receiving the third S-SSB from the second synchronization source or transmitting the third S-SSB from the second UE as the second synchronization source based on an S-SSB unavailability. For instance, the second UE 115-b (e.g., a sidelink UE) deriving an SL-SS identifier from the second S-SSB 230 may determine that the first synchronization source may be unavailable within a period (e.g., from a next synchronization slot, from a next frame, or after a configured or specified time gap, such as a synchronization deactivation period). In some approaches, the time gap may be configured based on configuration information received from another device (e.g., a network entity or another UE, for instance). In some aspects, the second UE 115-b (e.g., a sidelink UE) deriving an SL-SS identifier from the second S-SSB 230 may synchronize to an alternate synchronization source or become a synchronization source (e.g., if no synchronization source is available within a synchronization deactivation period).

In some approaches, the third S-SSB may be received with the first SL-SS identifier based on a reception, in an occasion, of the first S-SSB 225 including the first SL-SS identifier and the second S-SSB 230 including the second SL-SS. For instance, if the second UE 115-b receives, in an S-SSB occasion, two SL-SSs, where one SL-SS indicates a termination identifier (e.g., an identifier indicating a discontinuation of S-SSB transmission) and the other SL-SS indicates the original SL-SS identifier of the synchronization source, the second UE 115-b may utilize the first S-SSB 225 associated with the original SL-SS identifier to determine synchronization. In this example, S-SSBs from multiple sidelink UEs may have the same subframe number (SFN) on a same S-SSB resource. For instance, because SL-SS identifiers may be chosen based on a randomized algorithm, two or more UEs may have the same SL-SS identifier. In another example, the identifiers may be derived (e.g., may both be derived) from a GNSS or a network (e.g., gNB or eNB) source.

In some implementations or scenarios, it may be likely that another synchronization source is available (e.g., unlikely that another synchronization source is not available). In a case that another synchronization source is unavailable (e.g., in the absence of a synchronization source), a UE (e.g., the second UE 115-b or one of the UEs synchronized to the first UE 115-a that is going into ultra-deep sleep) may become an independent synchronization source based on the current timing of the UE.

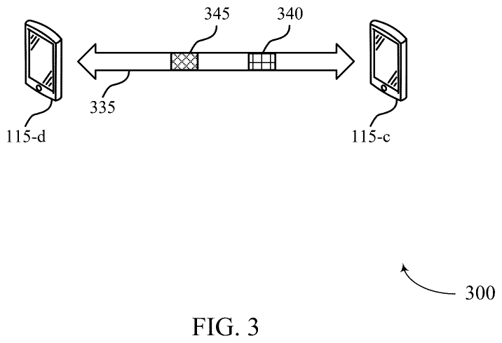

FIG. 3 shows an example of a wireless communications system 300 that supports sidelink synchronization signaling in accordance with one or more aspects of the present disclosure. The wireless communications system 300 may implement aspects of or may be implemented by aspects of the wireless communications system 100. For example, the wireless communications system 300 includes a first UE 115-c and a second UE 115-d, which may examples of the UE 115 described with reference to FIG. 1 or may be examples of one or more of the first UE 115-a or the second UE 115-b described with reference to FIG. 2.

The first UE 115-c may communicate with the second UE 115-d via a sidelink channel 335. The sidelink channel 335 may be a communication link between the first UE 115-c and the second UE 115-d (without an intervening network entity, for instance). The sidelink channel 335 may be established to provide unidirectional or bidirectional communications between the first UE 115-c and the second UE 115-d. For example, the sidelink channel 335 may carry one or more signals from the first UE 115-c to the second UE 115-d or one or more signals from the second UE 115-d to the first UE 115-c. For instance, one or more signals communicated between the first UE 115-c and the second UE 115-d may include one or more control signals or one or more data signals. In some aspects, the communication link 135 described with reference to FIG. 1 may be an example of the sidelink channel 335. Examples of the sidelink channel 335 may include a PSCCH, a PSSCH, a PSBCH, another channel, or any combination thereof.

Some examples of the techniques described with reference to FIG. 3 may relate to S-SSB reception in SL DRX. In an SL DRX state, a sidelink UE (e.g., the first UE 115-c) may monitor (e.g., “listen” to or attempt to receive a signal(s) from) one or more synchronization sources with a sparse synchronization reception schedule. A sparse synchronization (or S-SSB) reception schedule may be a reception schedule where S-SSB reception may occur in fewer occasions than occasions provided by configured resources. A UE that is transitioning to the SL DRX state may be synchronized with a peer UE to receive a WUS (e.g., a WUS that may only be successfully transmitted in accordance with the sparse synchronization reception schedule). Unlike some examples of a Uu interface, for instance, one or more peer sidelink UEs may not transmit synchronization signals (because only one or more UEs in the network may be synchronization sources, and a sidelink mode 2 synchronization source may not be a communication peer in some scenarios).

The second UE 115-d may transmit, or the first UE 115-c may receive, an indication 340 of a second S-SSB reception schedule with reduced S-SSB communication relative to a first S-SSB reception schedule. For example, the second UE 115-d (e.g., a sidelink UE transitioning to the SL DRX state or mode) may notify one or more peer UEs (e.g., the first UE 115-c or one or more sidelink UEs) of a sparse S-SSB reception schedule. For instance, the sparse S-SSB reception schedule may be a reception schedule where S-SSB transmission or reception may occur in fewer occasions than occasions provided by configured resources (e.g., the first S-SSB reception schedule). In some examples, the second UE 115-c (e.g., the sidelink UE transitioning to the SL DRX state) may activate a receiver (e.g., a receiver of the second UE 115-c) at the S-SSB resources in accordance with the second S-SSB reception schedule to monitor for one or more S-SSBs from one or more peer UEs (e.g., the first UE 115-c).

In some approaches, the indication 340 of the second S-SSB reception schedule may indicate a reduced periodicity relative to a periodicity of the first S-SSB reception schedule or may indicate a time-division duplexing (TDD) pattern. For example, the second S-SSB reception schedule (e.g., sparse synchronization reception schedule) may be indicated by indicating an updated periodicity (e.g., 240 ms, 320 ms, or 1024 ms, among other examples), or may be indicated by a TDD reception pattern over the periodic synchronization resources. In some approaches, the periodicity or the TDD reception pattern may be defined based on a reference slot or a slot offset.

In some approaches, the second UE 115-d (e.g., the sidelink UE transitioning to the SL DRX state or mode) may negotiate, with one or more peer UEs (e.g., the first UE 115-c), the second S-SSB reception schedule. For example, a proposed second S-SSB reception schedule may be indicated in a communication (e.g., transmission or reception) between UEs (e.g., between the first UE 115-c and the second UE 115-d). A responding UE may indicate a confirmation of the proposed second S-SSB reception schedule or may propose another second S-SSB reception schedule. In some approaches, the negotiation may continue until a proposed second S-SSB reception schedule is confirmed or until a threshold period (e.g., timeout period) is reached. In some approaches, the second UE 115-d (e.g., the sidelink UE transitioning to the SL DRX state or mode) may negotiate, with one or more peer UEs (e.g., the first UE 115-c), the second S-SSB reception schedule via one or more sidelink RRC messages.

In some aspects, the indication 340 of the second S-SSB reception schedule may be communicated via one or more RRC messages or via one or more media access control-control element (MAC-CE) messages via a sidelink (e.g., via the sidelink channel 335). For instance, the indication 340 (e.g., notification) may be based on one or more RRC messages or MAC CEs when the first UE 115-c and the second UE 115-d are linked (e.g., connected) via sidelink unicast or groupcast (e.g., unicast or groupcast based on one or more UE identifiers).

In some examples, resources of the second S-SSB reception schedule may be associated with one or more spatial filters. The one or more spatial filters may be quasi-co-located with one or more transmit beams of the first UE 115-c. For instance, resources of the second S-SSB reception schedule (e.g., the sparse S-SSB resources) may be associated with one or more receive spatial filters (e.g., one or more beam directions). One or more of the spatial filters may have an established (e.g., configured or specified) quasi-co-location relationship with the one or more beams used by the peer UE (e.g., the first UE 115-c) for data transmission.

In some approaches, the second UE 115-d (e.g., the sidelink UE transitioning to the SL DRX state or mode) may negotiate, with one or more peer UEs (e.g., each peer UE), an SL-SS identifier to receive from the peer UE. For example, a proposed SL-SS identifier may be indicated in a communication (e.g., transmission or reception) between UEs (e.g., between the first UE 115-c and the second UE 115-d). A responding UE may indicate a confirmation of the proposed SL-SS identifier or may propose another SL-SS identifier. In some approaches, the negotiation may continue until a proposed SL-SS identifier is confirmed or until a threshold period (e.g., timeout period) is reached. In some approaches, the SL-SS identifier may be selected from a set of SL-SS IDs that are used for SL DRX synchronization (e.g., for the second S-SSB reception schedule, or the sparse reception schedule), which may differ from a set of SL-SS IDs used for current sidelink synchronization (e.g., for non-DRX, default DRX, or the first S-SSB reception schedule).

The first UE 115-c may transmit, or the second UE 115-d may receive, a second S-SSB 345 including a second SL-SS identifier associated with the second S-SSB reception schedule. The second SL-SS identifier may be different from a first SL-SS identifier associated with the first S-SSB reception schedule. For instance, the first UE 115-c (e.g., a UE receiving an indication of a sparse S-SSB reception schedule from the second UE 115-d) may conditionally transmit the second S-SSB 345 on one or more of the indicated S-SSB opportunities (of the sparse or second S-SSB reception schedule) based on data traffic available for the second UE 115-d. In some approaches, the second SL-SS identifier indicated in the second S-SSB 345 may be based on signaling from the first UE 115-c. One or more other UEs may not utilize the second S-SSB 345 for synchronization (e.g., as a synchronization source). In some aspects, the second S-SSB 345 may be transmitted in one or more beam directions.

To trigger the second UE 115-d to monitor one or more slots than are included in the second S-SSB reception schedule (e.g., to transition out of SL DRX), the first UE 115-c (or another UE) may transmit an S-SSB in a slot of the second S-SSB reception schedule with the second SL-SS identifier. The first UE 115-c may transmit, or the second UE 115-d may receive, after the second S-SSB 345, sidelink paging SCI in a slot that is not included in the second S-SSB reception schedule, where the SCI indicates data to be transmitted to the second UE 115-d. For instance, if a peer UE (e.g., the first UE 115-c) transmits an S-SSB with the second SL-SS identifier, the second UE 115-d (in SL DRX) may activate a receiver at one or more sidelink slots to decode a sidelink paging SCI indicating one or more data transmissions.

In some examples, the first UE 115-c may transmit, or the second UE 115-d may receive, an indication of a third S-SSB reception schedule. The third S-SSB reception schedule may be based on predicted data traffic (e.g., data communications) for the second UE 115-d. For instance, the first UE 115-c may indicate one or more alternate sparse synchronization patterns (e.g., reception schedules) for the second UE 115-d (e.g., the UE going into SL DRX) based on the predicted data traffic.

In some approaches, the first UE 115-c may transmit, or the second UE 115-d may receive, an indication of a reception pattern. The second UE 115-d may activates a receiver for a combination of the second S-SSB reception schedule and the reception pattern. For instance, the second UE 115-d (e.g., the peer UE transitioning into SL DRX) may aggregate the updated sparse pattern(s) (e.g., the reception pattern) and the one or more previously indicated sparse patterns (e.g., the second S-SSB reception schedule).

In some aspects, the first UE 115-c may transmit, or the second UE 115-d may receive, an indication rejecting the second S-SSB reception schedule. The second UE 115-d may enter a DRX state or mode in response to the indication. For instance, the second UE 115-d may indicate that SL DRX (e.g., the second S-SSB reception schedule) is rejected (e.g., infeasible) or may enter another DRX state or mode (e.g., default DRX) to save power.

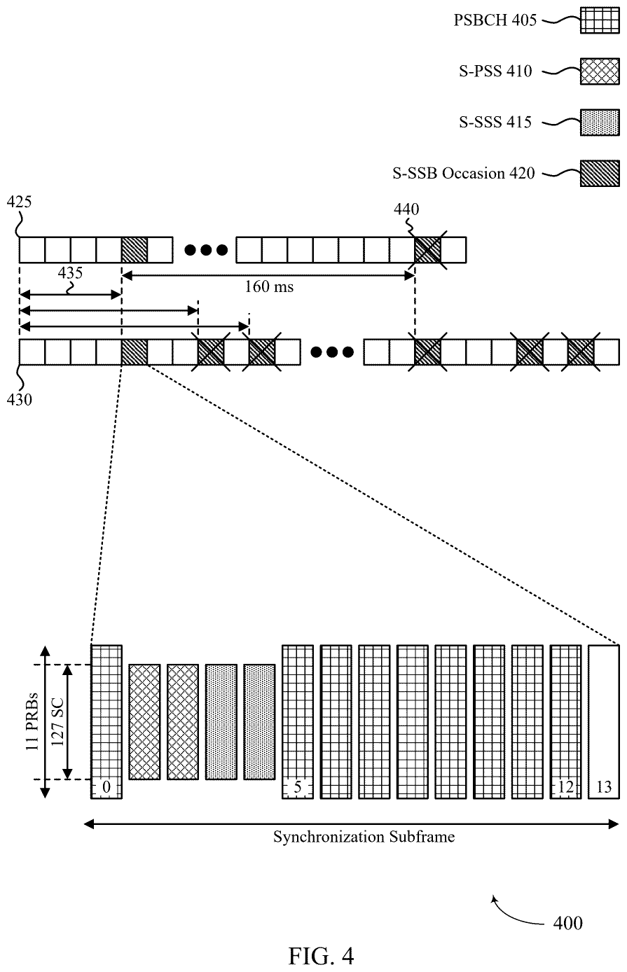

FIG. 4 shows an example of a timing diagram 400 that supports sidelink synchronization signaling in accordance with one or more aspects of the present disclosure. In particular, FIG. 4 illustrates first subframes 425 and second subframes 430. For example, the first subframes 425 may correspond to an in-coverage scenario (as received in a system information block (SIB)). The second subframes 430 may correspond to an out-of-coverage scenario (e.g., a pre-configuration scenario). The first subframes and the second subframes 430 are illustrated as beginning with SFN 0 or direct frame number (DFN) 0.

The first subframes 425 and the second subframes 430 may each include one or more S-SSB occasions 420. One or more offset indicators 435 (e.g., syncOffsetIndicators) may be utilized to schedule, allocate, or configure the S-SSB occasions 420. In some approaches, a radio access network (RAN) may ensure that an offset indicator 435 for a first S-SSB occasion is set the same as in pre-configuration. As illustrated in FIG. 4, the S-SSB occasions 420 may occur with different periodicities. For instance, S-SSB occasions in the first subframes 425 may occur with a 160 ms periodicity. FIG. 4 also illustrates an example of a synchronization subframe (e.g., an S-SSB). In the example of FIG. 4, a PSBCH 405 of the synchronization subframe includes up to 11 physical resource blocks (PRBs). An S-PSS 410 or an S-SSS 415 may occupy up to 127 subcarriers (SCs) in the example of FIG. 4. While some quantities (e.g., 160 ms, 11 PRBs, 127 SCs) are given in the example of FIG. 4, other examples in accordance with the systems and methods described herein may be implemented with one or more different quantities.

In accordance with some examples of the techniques described herein, a UE may deactivate communication circuitry or hardware (e.g., an OFDM receiver(s)) for one or more S-SSB occasions 420. As illustrated in FIG. 4, several of the S-SSB occasions 420 are crossed out 440, denoting that a UE may not transmit or receive one or more S-SSBs at one or more configured or established S-SSB occasions, which may reduce resource consumption while a UE is in an SL DRX state or mode.

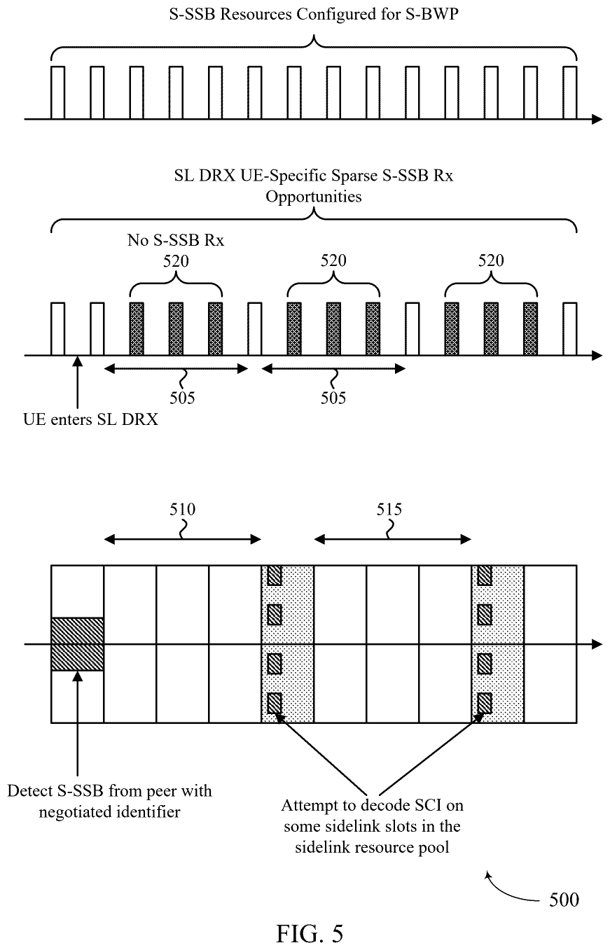

FIG. 5 shows an example of a timing diagram 500 that supports sidelink synchronization signaling in accordance with one or more aspects of the present disclosure. In particular, FIG. 5 illustrates an example of S-SSB resources configured for a sidelink bandwidth part (S-BWP). In accordance with some of the techniques described herein, a sidelink UE (e.g., first UE 115-a, second UE 115-b, first UE 115-c, or second UE 115-d) may use fewer than the configured resources for S-SSB transmission or reception while in an SL DRX state or mode. For instance, a UE may utilize the SL DRX UE-specific sparse S-SSB reception opportunities, where a portion 520 of the opportunities are not utilized for S-SSB reception. For instance, after a UE enters SL DRX, the utilized (e.g., sparse) S-SSB reception opportunities may be spaced in time by a quantity 505

$$( e . g . , {T}_{sparse}^{S - SSB} ) .$$

In some cases, sidelink UE may have a unicast session with a peer that has a bursty traffic pattern (e.g., aperiodic traffic with relatively long gaps). Periodic DRX may work for some cases where UEs have periodic or predictable traffic patterns. In some examples of the techniques described herein some paging (e.g., early paging) may improve performance for cases with bursty traffic when SL DRX is utilized. For example, a receiver UE that is transitioning (or will transition) to the SL DRX state mode may notify a peer UE that is transmitting bursty traffic to conditionally transmit an S-SSB in one of the sparse S-SSB reception opportunities if data traffic is available for the UE.

When traffic is available for the UE in the SL DRX state or mode, for instance, a peer UE may transmit an S-SSB with a negotiated identifier. The UE may receive (e.g., detect) the S-SSB with the negotiated SL-SS identifier, and may attempt to decode one or more SCIs on one or more slots that have a relationship (e.g., fixed relationship) with the S-SSB resource. As illustrated in FIG. 5, the slots may be configured (e.g., configured via signaling from a network entity or other device) or established (e.g., specified) to be a time 510

$$( e . g . , {T}_{proc}^{eDRX} )$$

from the sidelink synchronization resource (of the S-SSB with the negotiated identifier) and may occur N times (e.g., twice) with a gap 515

$$( e . g . , {T}_{gap}^{eDRX} ) .$$

After detecting or decoding an SCI, the UE may exit the SL DRX state or mode. In some cases, the UE may return to the SL DRX state at a time (e.g., a threshold time) after an end of the bursty data transmission(s).

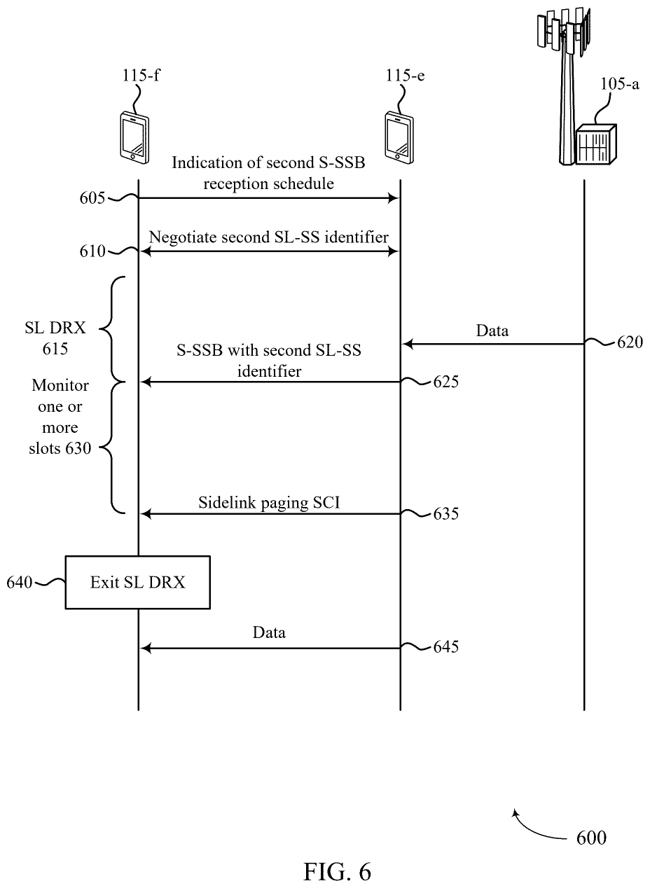

FIG. 6 shows an example of a process flow 600 that supports sidelink synchronization signaling in accordance with one or more aspects of the present disclosure. The process flow 600 may include a first UE 115-e and a second UE 115-f, which may be examples of one or more of the UEs 115, first UE 115-a, second UE 115-b, first UE 115-c, or second UE 115-d, as described herein. The process flow 600 may also include a network entity 105-a, which may be an example of one or more of the network entities 105, as described herein.

In the following description of the process flow 600, the operations between the network entity 105-a, the first UE 115-e, and the second UE 115-f may be transmitted in a different order than the example order shown, or the operations performed by the network entity 105-a, the first UE 115-e, and the second UE 115-f may be performed in different orders or at different times. Some operations may also be omitted from the process flow 600, or other operations may be added to the process flow 600. Further, although some operations or signaling may be shown to occur at different times for discussion purposes, these operations may actually occur at the same time or in overlapping time periods.

At 605, the second UE 115-f may transmit, or the first UE 115-e may receive, an indication of a second S-SSB reception schedule. For instance, the first UE 115-e may receive an indication of a second S-SSB reception schedule with reduced S-SSB communication as described with reference to FIG. 3.

At 610, the first UE 115-e and the second UE 115-f may negotiate a second SL-SS identifier. For instance, the first UE 115-e and the second UE 115-f may negotiate a second SL-SS identifier associated with the second S-SSB reception schedule, where the second SL-SS identifier is different from a first SL-SS identifier associated with a S-SSB reception schedule as described with reference to FIG. 3.

At 615, the second UE 115-f may enter or operate in accordance with an SL DRX state or mode (e.g., the second S-SSB reception schedule). For instance, the second UE 115-f may deactivate a receiver during one or more configured S-SSB occasions as described with reference to FIG. 3.

At 620, the network entity 105-a may output (e.g., transmit) data (e.g., data for the second UE 115-f) to the first UE 115-e. For instance, the network entity 105-a may transmit data (e.g., payload data) to the first UE 115-e that is addressed to the second UE 115-f.

At 625, the first UE 115-e may transmit an S-SSB with the second SL-SS identifier to the second UE 115-f. For instance, the first UE 115-e may transmit an S-SSB with the second SL-SS identifier during a slot when the receiver of the second UE 115-f is active in accordance with the second S-SSB reception schedule as described with reference to FIG. 3.

At 630, the second UE 115-e may monitor one or more slots. For example, the second UE 115-f may activate a receiver during one or more additional slots to monitor for a sideline paging SCI as described with reference to FIG. 3 or FIG. 5.

At 635, the first UE 115-e may transmit sidelink paging SCI to the second UE 115-f. For example, the first UE 115-e may transmit sidelink paging SCI during the one or more additional slots as described with reference to FIG. 3 or FIG. 5.

At 640, the second UE 115-f may exit the SL DRX state or mode. For example, the second UE 115-f may activate the receiver to enter a non-DRX state or mode as described with reference to FIG. 3.

At 645, the first UE 115-e may transmit the data to the second UE 115-f. For example, the first UE 115-e may transmit (e.g., relay) the data that was received from the network entity 105-a to the second UE 115-f.

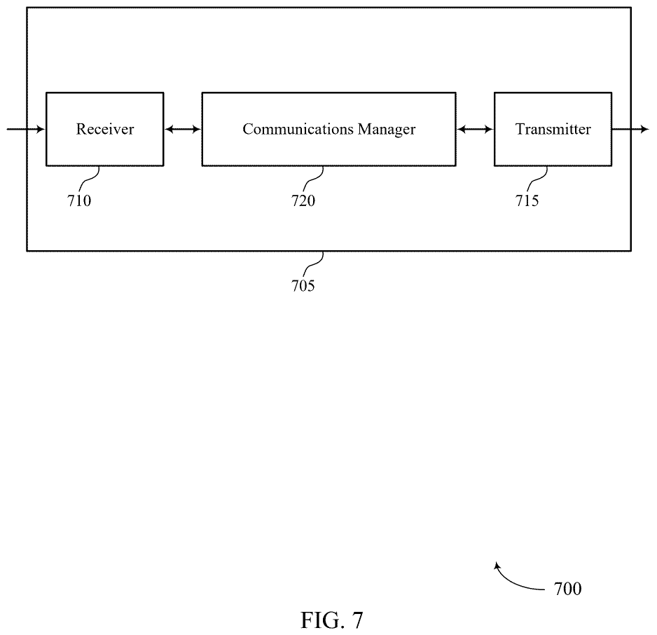

FIG. 7 shows a block diagram 700 of a device 705 that supports sidelink synchronization signaling in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to sidelink synchronization signaling). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to sidelink synchronization signaling). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of sidelink synchronization signaling as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for transmitting a first sidelink synchronization signal block (S-SSB) from the first UE as a first synchronization source, where the first S-SSB includes a first SL-SS identifier. The communications manager 720 is capable of, configured to, or operable to support a means for transmitting a second S-SSB, where the second S-SSB includes a second SL-SS identifier indicating a discontinuation of S-SSB transmission by the first UE.

Additionally, or alternatively, the communications manager 720 may support wireless communications in accordance with examples as disclosed herein. For example, the communications manager 720 is capable of, configured to, or operable to support a means for receiving a first S-SSB from a first UE as a first synchronization source, where the first S-SSB includes a first SL-SS identifier. The communications manager 720 is capable of, configured to, or operable to support a means for receiving a second S-SSB, where the second S-SSB includes a second SL-SS identifier indicating a discontinuation of S-SSB transmission by the first UE.

Additionally, or alternatively, the communications manager 720 may support wireless communications in accordance with examples as disclosed herein. For example, the communications manager 720 is capable of, configured to, or operable to support a means for receiving, from a second UE, an indication of a second S-SSB reception schedule with reduced S-SSB communication relative to a first S-SSB reception schedule. The communications manager 720 is capable of, configured to, or operable to support a means for transmitting a second S-SSB including a second SL-SS identifier associated with the second S-SSB reception schedule, where the second SL-SS identifier is different from a first SL-SS identifier associated with the first S-SSB reception schedule.

Additionally, or alternatively, the communications manager 720 may support wireless communications in accordance with examples as disclosed herein. For example, the communications manager 720 is capable of, configured to, or operable to support a means for transmitting, to a first UE, an indication of a second S-SSB reception schedule with reduced S-SSB communication relative to a first S-SSB reception schedule. The communications manager 720 is capable of, configured to, or operable to support a means for receiving a second S-SSB including a second SL-SS identifier associated with the second S-SSB reception schedule, where the second SL-SS identifier is different from a first SL-SS identifier associated with the first S-SSB reception schedule.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reduced processing, reduced power consumption, or more efficient utilization of communication resources.

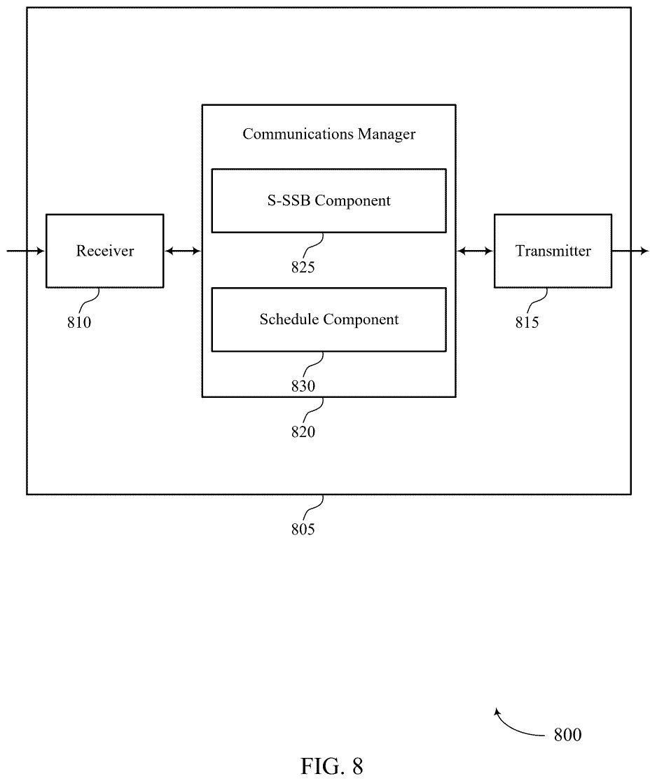

FIG. 8 shows a block diagram 800 of a device 805 that supports sidelink synchronization signaling in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to sidelink synchronization signaling). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to sidelink synchronization signaling). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of sidelink synchronization signaling as described herein. For example, the communications manager 820 may include an S-SSB component 825 a schedule component 830, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The S-SSB component 825 is capable of, configured to, or operable to support a means for transmitting a first S-SSB from the first UE as a first synchronization source, where the first S-SSB includes a first SL-SS identifier. The S-SSB component 825 is capable of, configured to, or operable to support a means for transmitting a second S-SSB, where the second S-SSB includes a second SL-SS identifier indicating a discontinuation of S-SSB transmission by the first UE.

Additionally, or alternatively, the communications manager 820 may support wireless communications in accordance with examples as disclosed herein. The S-SSB component 825 is capable of, configured to, or operable to support a means for receiving a first S-SSB from a first UE as a first synchronization source, where the first S-SSB includes a first SL-SS identifier. The S-SSB component 825 is capable of, configured to, or operable to support a means for receiving a second S-SSB, where the second S-SSB includes a second SL-SS identifier indicating a discontinuation of S-SSB transmission by the first UE.

Additionally, or alternatively, the communications manager 820 may support wireless communications in accordance with examples as disclosed herein. The schedule component 830 is capable of, configured to, or operable to support a means for receiving, from a second UE, an indication of a second S-SSB reception schedule with reduced S-SSB communication relative to a first S-SSB reception schedule. The S-SSB component 825 is capable of, configured to, or operable to support a means for transmitting a second S-SSB including a second SL-SS identifier associated with the second S-SSB reception schedule, where the second SL-SS identifier is different from a first SL-SS identifier associated with the first S-SSB reception schedule.

Additionally, or alternatively, the communications manager 820 may support wireless communications in accordance with examples as disclosed herein. The schedule component 830 is capable of, configured to, or operable to support a means for transmitting, to a first UE, an indication of a second S-SSB reception schedule with reduced S-SSB communication relative to a first S-SSB reception schedule. The S-SSB component 825 is capable of, configured to, or operable to support a means for receiving a second S-SSB including a second SL-SS identifier associated with the second S-SSB reception schedule, where the second SL-SS identifier is different from a first SL-SS identifier associated with the first S-SSB reception schedule.

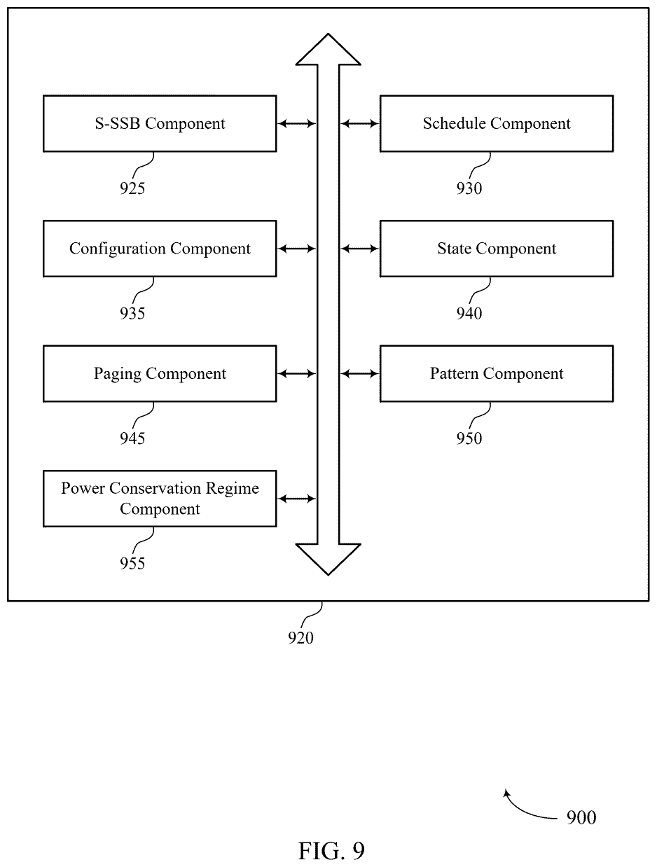

FIG. 9 shows a block diagram 900 of a communications manager 920 that supports sidelink synchronization signaling in accordance with one or more aspects of the present disclosure. The communications manager 920 may be an example of aspects of a communications manager 720, a communications manager 820, or both, as described herein. The communications manager 920, or various components thereof, may be an example of means for performing various aspects of sidelink synchronization signaling as described herein. For example, the communications manager 920 may include an S-SSB component 925, a schedule component 930, a configuration component 935, a state component 940, a paging component 945, a pattern component 950, a power conservation regime component 955, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The S-SSB component 925 is capable of, configured to, or operable to support a means for transmitting a first S-SSB from the first UE as a first synchronization source, where the first S-SSB includes a first SL-SS identifier. In some examples, the S-SSB component 925 is capable of, configured to, or operable to support a means for transmitting a second S-SSB, where the second S-SSB includes a second SL-SS identifier indicating a discontinuation of S-SSB transmission by the first UE.

In some examples, the configuration component 935 is capable of, configured to, or operable to support a means for receiving configuration information indicating the second SL-SS identifier for indicating the discontinuation of S-SSB transmission by the first UE.

In some examples, the second SL-SS identifier for indicating the discontinuation of S-SSB transmission by the first UE is selected from a set of SL-SS identifiers.

In some examples, the second SL-SS identifier for indicating the discontinuation of S-SSB transmission by the first UE is based on the first SL-SS identifier associated with the first S-SSB from the first UE as the first synchronization source.

In some examples, the second SL-SS identifier for indicating the discontinuation of S-SSB transmission by the first UE is based on a combination of the first SL-SS identifier and a static value.

In some examples, the second S-SSB including the second SL-SS identifier for indicating the discontinuation of S-SSB transmission by the first UE is transmitted on a same resource in a frequency domain as the first S-SSB.

In some examples, the state component 940 is capable of, configured to, or operable to support a means for entering a sidelink discontinuous reception (SL DRX) state associated with the discontinuation of S-SSB transmission by the first UE. In some examples, the state component 940 is capable of, configured to, or operable to support a means for entering an awake state after the SL DRX state, where the first UE synchronizes with another UE based on another S-SSB or resumes S-SSB transmission based on an S-SSB unavailability.

In some examples, the first S-SSB is associated with a first power conservation regime that consumes less power than a second power conservation regime. In some examples, the second S-SSB including the second SL-SS identifier indicating the discontinuation of S-SSB transmission by the first UE is associated with the first power conservation regime.

In some examples, the power conservation regime component 955 is capable of, configured to, or operable to support a means for resuming the S-SSB transmission associated with the first power conservation regime after the discontinuation of S-SSB transmission by the first UE.

In some examples, the S-SSB component 925 is capable of, configured to, or operable to support a means for receiving a third S-SSB from a second synchronization source after the discontinuation of S-SSB transmission by the first UE.

Additionally, or alternatively, the communications manager 920 may support wireless communications in accordance with examples as disclosed herein. In some examples, the S-SSB component 925 is capable of, configured to, or operable to support a means for receiving a first S-SSB from a first UE as a first synchronization source, where the first S-SSB includes a first SL-SS identifier. In some examples, the S-SSB component 925 is capable of, configured to, or operable to support a means for receiving a second S-SSB, where the second S-SSB includes a second SL-SS identifier indicating a discontinuation of S-SSB transmission by the first UE.

In some examples, the S-SSB component 925 is capable of, configured to, or operable to support a means for participating in communication of a third S-SSB from a second synchronization source after the discontinuation of S-SSB transmission by the first UE.

In some examples, participating in the communication of the third S-SSB includes receiving the third S-SSB from the second synchronization source or transmitting the third S-SSB from the second UE as the second synchronization source based on an S-SSB unavailability.

In some examples, the third S-SSB is received with the first SL-SS identifier based on a reception, in an occasion, of the first S-SSB including the first SL-SS identifier and the second S-SSB including the second S-SSB.

Additionally, or alternatively, the communications manager 920 may support wireless communications in accordance with examples as disclosed herein. The schedule component 930 is capable of, configured to, or operable to support a means for receiving, from a second UE, an indication of a second S-SSB reception schedule with reduced S-SSB communication relative to a first S-SSB reception schedule. In some examples, the S-SSB component 925 is capable of, configured to, or operable to support a means for transmitting a second S-SSB including a second SL-SS identifier associated with the second S-SSB reception schedule, where the second SL-SS identifier is different from a first SL-SS identifier associated with the first S-SSB reception schedule.

In some examples, the paging component 945 is capable of, configured to, or operable to support a means for transmitting, after the second S-SSB, sidelink paging SCI in a slot that is not included in the second S-SSB reception schedule, where the SCI indicates data to be transmitted to the second UE.

In some examples, the indication of the second S-SSB reception schedule indicates a reduced periodicity relative to a periodicity of the first S-SSB reception schedule or indicates a TDD pattern.

In some examples, the schedule component 930 is capable of, configured to, or operable to support a means for transmitting an indication of a third S-SSB reception schedule, where the third S-SSB reception schedule is based on predicted data traffic for the second UE.

Additionally, or alternatively, the communications manager 920 may support wireless communications in accordance with examples as disclosed herein. In some examples, the schedule component 930 is capable of, configured to, or operable to support a means for transmitting, to a first UE, an indication of a second S-SSB reception schedule with reduced S-SSB communication relative to a first S-SSB reception schedule. In some examples, the S-SSB component 925 is capable of, configured to, or operable to support a means for receiving a second S-SSB including a second SL-SS identifier associated with the second S-SSB reception schedule, where the second SL-SS identifier is different from a first SL-SS identifier associated with the first S-SSB reception schedule.

In some examples, the paging component 945 is capable of, configured to, or operable to support a means for receiving, after the second S-SSB, sidelink paging SCI in a slot that is not included in the second S-SSB reception schedule, where the SCI indicates data to be transmitted to the second UE.

In some examples, the indication of the second S-SSB reception schedule indicates a reduced periodicity relative to a periodicity of the first S-SSB reception schedule or indicates a TDD pattern.

In some examples, the indication of the second S-SSB reception schedule is communicated via one or more RRC messages or via one or more MAC-CE messages via a sidelink.

In some examples, resources of the second S-SSB reception schedule are associated with one or more spatial filters. In some examples, the one or more spatial filters are quasi-co-located with one or more transmit beams of the first UE.

In some examples, the schedule component 930 is capable of, configured to, or operable to support a means for receiving an indication of a third S-SSB reception schedule, where the third S-SSB reception schedule is based on predicted data traffic for the second UE.

In some examples, the pattern component 950 is capable of, configured to, or operable to support a means for receiving an indication of a reception pattern, where the second UE activates a receiver for a combination of the second S-SSB reception schedule and the reception pattern.

In some examples, the schedule component 930 is capable of, configured to, or operable to support a means for receiving an indication rejecting the second S-SSB reception schedule. In some examples, the state component 940 is capable of, configured to, or operable to support a means for entering a DRX state in response to the indication.

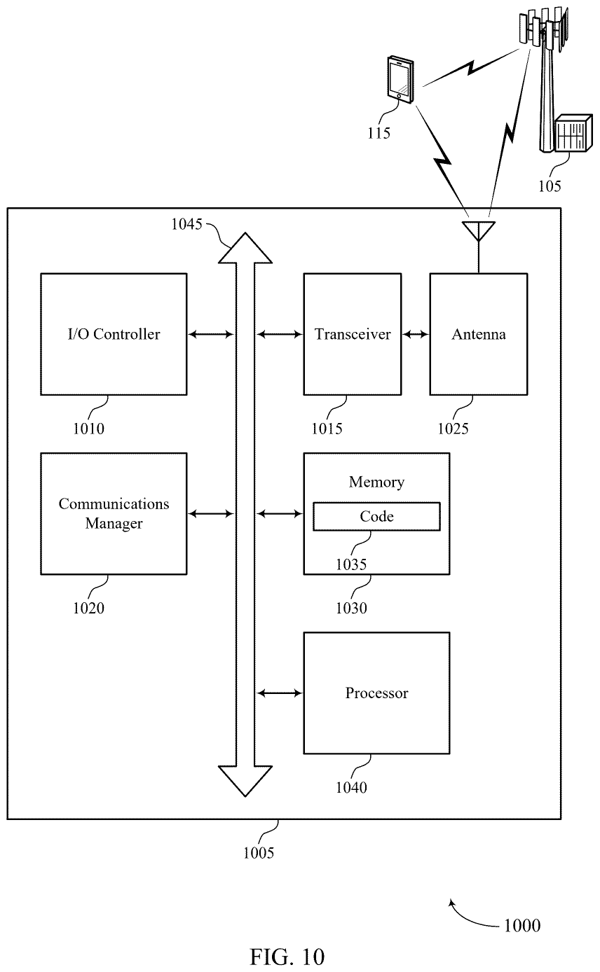

FIG. 10 shows a diagram of a system 1000 including a device 1005 that supports sidelink synchronization signaling in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting sidelink synchronization signaling). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for transmitting a first S-SSB from the first UE as a first synchronization source, where the first S-SSB includes a first SL-SS identifier. The communications manager 1020 is capable of, configured to, or operable to support a means for transmitting a second S-SSB, where the second S-SSB includes a second SL-SS identifier indicating a discontinuation of S-SSB transmission by the first UE.

Additionally, or alternatively, the communications manager 1020 may support wireless communications in accordance with examples as disclosed herein. For example, the communications manager 1020 is capable of, configured to, or operable to support a means for receiving a first S-SSB from a first UE as a first synchronization source, where the first S-SSB includes a first SL-SS identifier. The communications manager 1020 is capable of, configured to, or operable to support a means for receiving a second S-SSB, where the second S-SSB includes a second SL-SS identifier indicating a discontinuation of S-SSB transmission by the first UE.

Additionally, or alternatively, the communications manager 1020 may support wireless communications in accordance with examples as disclosed herein. For example, the communications manager 1020 is capable of, configured to, or operable to support a means for receiving, from a second UE, an indication of a second S-SSB reception schedule with reduced S-SSB communication relative to a first S-SSB reception schedule. The communications manager 1020 is capable of, configured to, or operable to support a means for transmitting a second S-SSB including a second SL-SS identifier associated with the second S-SSB reception schedule, where the second SL-SS identifier is different from a first SL-SS identifier associated with the first S-SSB reception schedule.

Additionally, or alternatively, the communications manager 1020 may support wireless communications in accordance with examples as disclosed herein. For example, the communications manager 1020 is capable of, configured to, or operable to support a means for transmitting, to a first UE, an indication of a second S-SSB reception schedule with reduced S-SSB communication relative to a first S-SSB reception schedule. The communications manager 1020 is capable of, configured to, or operable to support a means for receiving a second S-SSB including a second SL-SS identifier associated with the second S-SSB reception schedule, where the second SL-SS identifier is different from a first SL-SS identifier associated with the first S-SSB reception schedule.

By including or configuring the communications manager 1020 in accordance with examples as described herein, the device 1005 may support techniques for improved communication reliability, improved user experience related to reduced processing, reduced power consumption, more efficient utilization of communication resources, improved coordination between devices, longer battery life, or improved utilization of processing capability.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of sidelink synchronization signaling as described herein, or the at least one processor 1040 and the at least one memory 1030 may be otherwise configured to, individually or collectively, perform or support such operations.

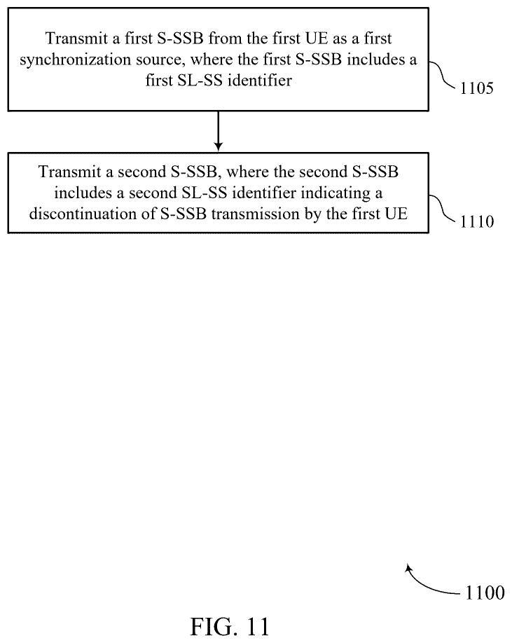

FIG. 11 shows a flowchart illustrating a method 1100 that supports sidelink synchronization signaling in accordance with one or more aspects of the present disclosure. The operations of the method 1100 may be implemented by a UE or its components as described herein. For example, the operations of the method 1100 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1105, the method may include transmitting a first S-SSB from the first UE as a first synchronization source, where the first S-SSB includes a first SL-SS identifier. The operations of 1105 may be performed in accordance with examples as disclosed herein. In some examples, aspects of the operations of 1105 may be performed by an S-SSB component 925 as described with reference to FIG. 9.

At 1110, the method may include transmitting a second S-SSB, where the second S-SSB includes a second SL-SS identifier indicating a discontinuation of S-SSB transmission by the first UE. The operations of 1110 may be performed in accordance with examples as disclosed herein. In some examples, aspects of the operations of 1110 may be performed by an S-SSB component 925 as described with reference to FIG. 9.

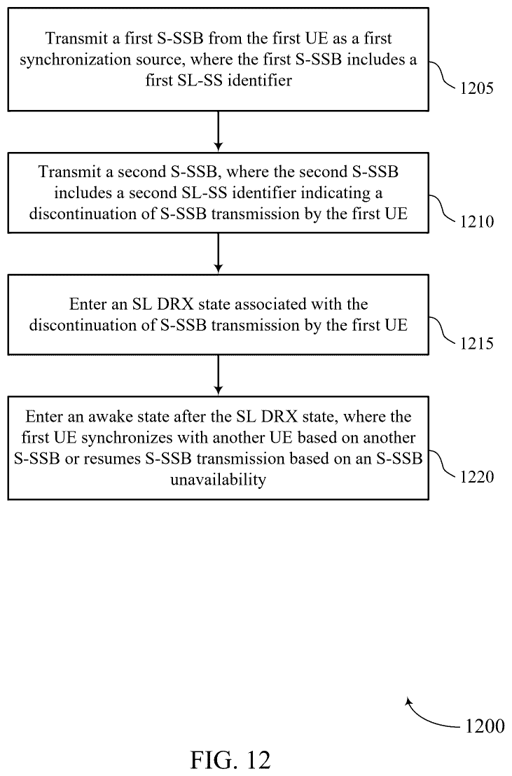

FIG. 12 shows a flowchart illustrating a method 1200 that supports sidelink synchronization signaling in accordance with one or more aspects of the present disclosure. The operations of the method 1200 may be implemented by a UE or its components as described herein. For example, the operations of the method 1200 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1205, the method may include transmitting a first S-SSB from the first UE as a first synchronization source, where the first S-SSB includes a first SL-SS identifier. The operations of 1205 may be performed in accordance with examples as disclosed herein. In some examples, aspects of the operations of 1205 may be performed by an S-SSB component 925 as described with reference to FIG. 9.

At 1210, the method may include transmitting a second S-SSB, where the second S-SSB includes a second SL-SS identifier indicating a discontinuation of S-SSB transmission by the first UE. The operations of 1210 may be performed in accordance with examples as disclosed herein. In some examples, aspects of the operations of 1210 may be performed by an S-SSB component 925 as described with reference to FIG. 9.

At 1215, the method may include entering a sidelink discontinuous reception (SL DRX) state associated with the discontinuation of S-SSB transmission by the first UE. The operations of 1215 may be performed in accordance with examples as disclosed herein. In some examples, aspects of the operations of 1215 may be performed by a state component 940 as described with reference to FIG. 9.

At 1220, the method may include entering an awake state after the SL DRX state, where the first UE synchronizes with another UE based on another S-SSB or resumes S-SSB transmission based on an S-SSB unavailability. The operations of 1220 may be performed in accordance with examples as disclosed herein. In some examples, aspects of the operations of 1220 may be performed by a state component 940 as described with reference to FIG. 9.

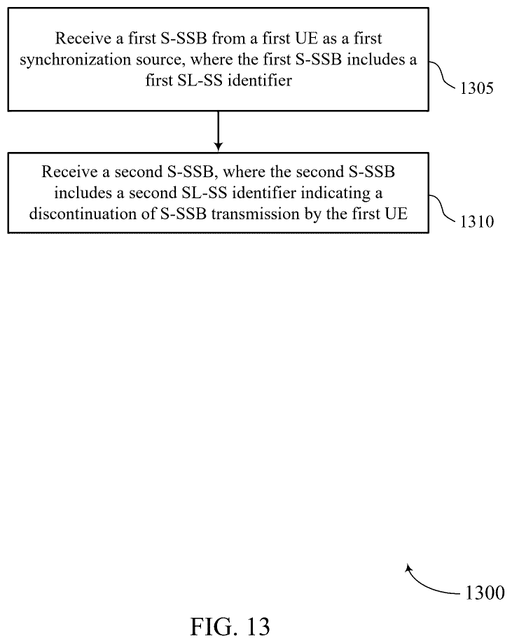

FIG. 13 shows a flowchart illustrating a method 1300 that supports sidelink synchronization signaling in accordance with one or more aspects of the present disclosure. The operations of the method 1300 may be implemented by a UE or its components as described herein. For example, the operations of the method 1300 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1305, the method may include receiving a first S-SSB from a first UE as a first synchronization source, where the first S-SSB includes a first SL-SS identifier. The operations of 1305 may be performed in accordance with examples as disclosed herein. In some examples, aspects of the operations of 1305 may be performed by an S-SSB component 925 as described with reference to FIG. 9.

At 1310, the method may include receiving a second S-SSB, where the second S-SSB includes a second SL-SS identifier indicating a discontinuation of S-SSB transmission by the first UE. The operations of 1310 may be performed in accordance with examples as disclosed herein. In some examples, aspects of the operations of 1310 may be performed by an S-SSB component 925 as described with reference to FIG. 9.

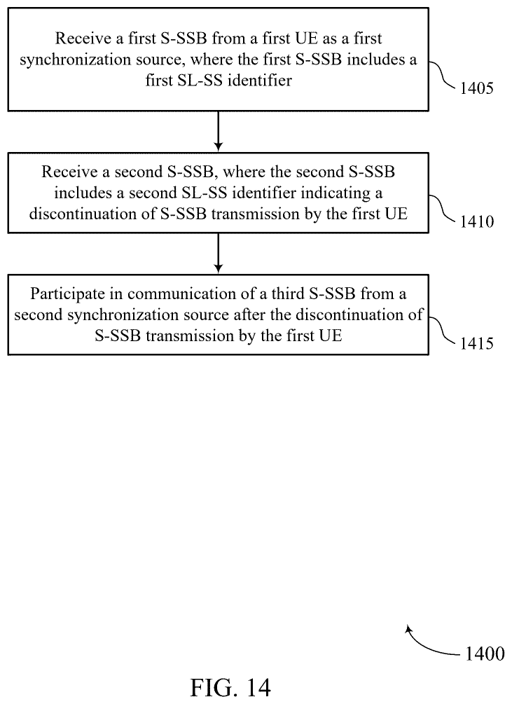

FIG. 14 shows a flowchart illustrating a method 1400 that supports sidelink synchronization signaling in accordance with one or more aspects of the present disclosure. The operations of the method 1400 may be implemented by a UE or its components as described herein. For example, the operations of the method 1400 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1405, the method may include receiving a first S-SSB from a first UE as a first synchronization source, where the first S-SSB includes a first SL-SS identifier. The operations of 1405 may be performed in accordance with examples as disclosed herein. In some examples, aspects of the operations of 1405 may be performed by an S-SSB component 925 as described with reference to FIG. 9.

At 1410, the method may include receiving a second S-SSB, where the second S-SSB includes a second SL-SS identifier indicating a discontinuation of S-SSB transmission by the first UE. The operations of 1410 may be performed in accordance with examples as disclosed herein. In some examples, aspects of the operations of 1410 may be performed by an S-SSB component 925 as described with reference to FIG. 9.

At 1415, the method may include participating in communication of a third S-SSB from a second synchronization source after the discontinuation of S-SSB transmission by the first UE. The operations of 1415 may be performed in accordance with examples as disclosed herein. In some examples, aspects of the operations of 1415 may be performed by an S-SSB component 925 as described with reference to FIG. 9.

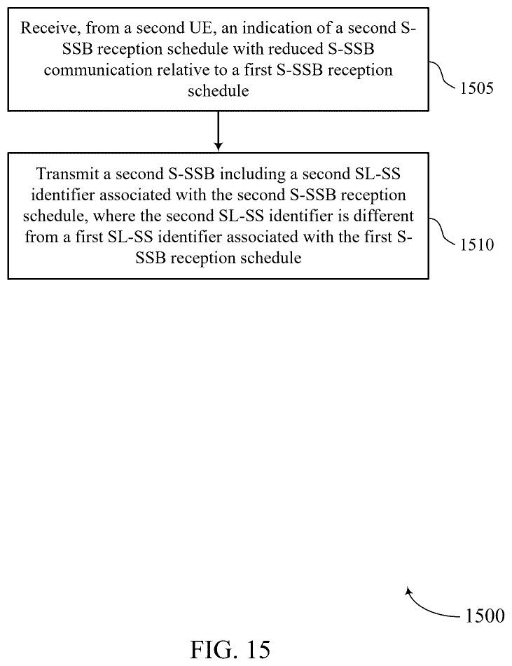

FIG. 15 shows a flowchart illustrating a method 1500 that supports sidelink synchronization signaling in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving, from a second UE, an indication of a second S-SSB reception schedule with reduced S-SSB communication relative to a first S-SSB reception schedule. The operations of 1505 may be performed in accordance with examples as disclosed herein. In some examples, aspects of the operations of 1505 may be performed by a schedule component 930 as described with reference to FIG. 9.

At 1510, the method may include transmitting a second S-SSB including a second SL-SS identifier associated with the second S-SSB reception schedule, where the second SL-SS identifier is different from a first SL-SS identifier associated with the first S-SSB reception schedule. The operations of 1510 may be performed in accordance with examples as disclosed herein. In some examples, aspects of the operations of 1510 may be performed by an S-SSB component 925 as described with reference to FIG. 9.

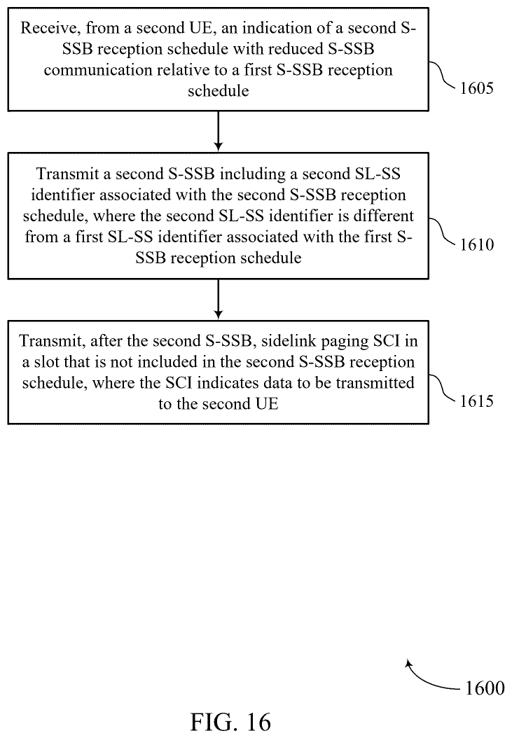

FIG. 16 shows a flowchart illustrating a method 1600 that supports sidelink synchronization signaling in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving, from a second UE, an indication of a second S-SSB reception schedule with reduced S-SSB communication relative to a first S-SSB reception schedule. The operations of 1605 may be performed in accordance with examples as disclosed herein. In some examples, aspects of the operations of 1605 may be performed by a schedule component 930 as described with reference to FIG. 9.

At 1610, the method may include transmitting a second S-SSB including a second SL-SS identifier associated with the second S-SSB reception schedule, where the second SL-SS identifier is different from a first SL-SS identifier associated with the first S-SSB reception schedule. The operations of 1610 may be performed in accordance with examples as disclosed herein. In some examples, aspects of the operations of 1610 may be performed by an S-SSB component 925 as described with reference to FIG. 9.

At 1615, the method may include transmitting, after the second S-SSB, sidelink paging SCI in a slot that is not included in the second S-SSB reception schedule, where the SCI indicates data to be transmitted to the second UE. The operations of 1615 may be performed in accordance with examples as disclosed herein. In some examples, aspects of the operations of 1615 may be performed by a paging component 945 as described with reference to FIG. 9.

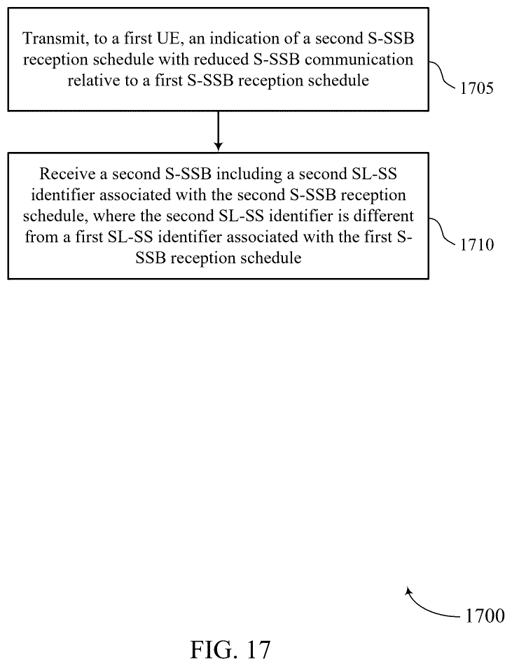

FIG. 17 shows a flowchart illustrating a method 1700 that supports sidelink synchronization signaling in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include transmitting, to a first UE, an indication of a second S-SSB reception schedule with reduced S-SSB communication relative to a first S-SSB reception schedule. The operations of 1705 may be performed in accordance with examples as disclosed herein. In some examples, aspects of the operations of 1705 may be performed by a schedule component 930 as described with reference to FIG. 9.

At 1710, the method may include receiving a second S-SSB including a second SL-SS identifier associated with the second S-SSB reception schedule, where the second SL-SS identifier is different from a first SL-SS identifier associated with the first S-SSB reception schedule. The operations of 1710 may be performed in accordance with examples as disclosed herein. In some examples, aspects of the operations of 1710 may be performed by an S-SSB component 925 as described with reference to FIG. 9.

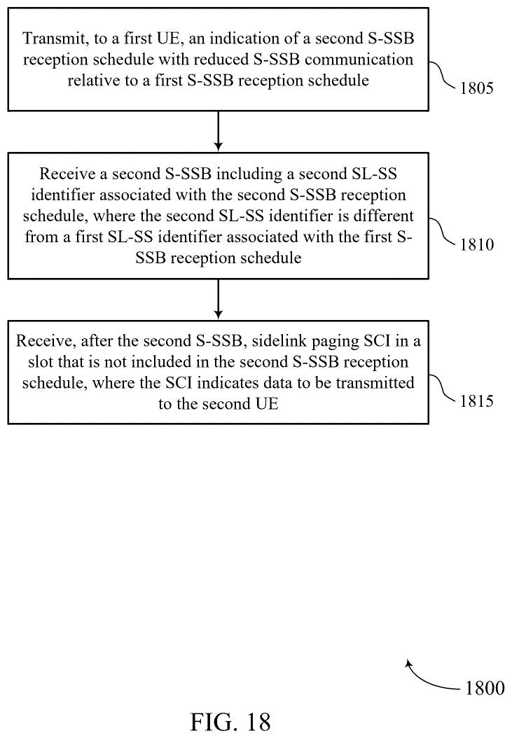

FIG. 18 shows a flowchart illustrating a method 1800 that supports sidelink synchronization signaling in accordance with one or more aspects of the present disclosure. The operations of the method 1800 may be implemented by a UE or its components as described herein. For example, the operations of the method 1800 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1805, the method may include transmitting, to a first UE, an indication of a second S-SSB reception schedule with reduced S-SSB communication relative to a first S-SSB reception schedule. The operations of 1805 may be performed in accordance with examples as disclosed herein. In some examples, aspects of the operations of 1805 may be performed by a schedule component 930 as described with reference to FIG. 9.

At 1810, the method may include receiving a second S-SSB including a second SL-SS identifier associated with the second S-SSB reception schedule, where the second SL-SS identifier is different from a first SL-SS identifier associated with the first S-SSB reception schedule. The operations of 1810 may be performed in accordance with examples as disclosed herein. In some examples, aspects of the operations of 1810 may be performed by an S-SSB component 925 as described with reference to FIG. 9.

At 1815, the method may include receiving, after the second S-SSB, sidelink paging SCI in a slot that is not included in the second S-SSB reception schedule, where the SCI indicates data to be transmitted to the second UE. The operations of 1815 may be performed in accordance with examples as disclosed herein. In some examples, aspects of the operations of 1815 may be performed by a paging component 945 as described with reference to FIG. 9.

The following provides an overview of aspects of the present disclosure:

Aspect 1: A method for wireless communications at a first UE, comprising: transmitting a first S-SSB from the first UE as a first synchronization source, wherein the first S-SSB comprises a first SL-SS identifier; and transmitting a second S-SSB, wherein the second S-SSB comprises a second SL-SS identifier indicating a discontinuation of S-SSB transmission by the first UE.

Aspect 2: The method of aspect 1, further comprising: receiving configuration information indicating the second SL-SS identifier for indicating the discontinuation of S-SSB transmission by the first UE.

Aspect 3: The method of any of aspects 1 through 2, wherein the second SL-SS identifier for indicating the discontinuation of S-SSB transmission by the first UE is selected from a set of SL-SS identifiers.

Aspect 4: The method of any of aspects 1 through 3, wherein the second SL-SS identifier for indicating the discontinuation of S-SSB transmission by the first UE is based at least in part on the first SL-SS identifier associated with the first S-SSB from the first UE as the first synchronization source.

Aspect 5: The method of aspect 4, wherein the second SL-SS identifier for indicating the discontinuation of S-SSB transmission by the first UE is based at least in part on a combination of the first SL-SS identifier and a static value.

Aspect 6: The method of any of aspects 1 through 5, wherein the second S-SSB comprising the second SL-SS identifier for indicating the discontinuation of S-SSB transmission by the first UE is transmitted on a same resource in a frequency domain as the first S-SSB.

Aspect 7: The method of any of aspects 1 through 6, further comprising: entering a sidelink discontinuous reception (SL DRX) state associated with the discontinuation of S-SSB transmission by the first UE; and entering an awake state after the SL DRX state, wherein the first UE synchronizes with another UE based at least in part on another S-SSB or resumes S-SSB transmission based at least in part on an S-SSB unavailability.

Aspect 8: The method of any of aspects 1 through 7, wherein the first S-SSB is associated with a first power conservation regime that consumes less power than a second power conservation regime, and the second S-SSB comprising the second SL-SS identifier indicating the discontinuation of S-SSB transmission by the first UE is associated with the first power conservation regime.

Aspect 9: The method of aspect 8, further comprising: resuming the S-SSB transmission associated with the first power conservation regime after the discontinuation of S-SSB transmission by the first UE.

Aspect 10: The method of any of aspects 1 through 9, further comprising: receiving a third S-SSB from a second synchronization source after the discontinuation of S-SSB transmission by the first UE.

Aspect 11: A method for wireless communications at a second UE, comprising: receiving a first S-SSB from a first UE as a first synchronization source, wherein the first S-SSB comprises a first SL-SS identifier; and receiving a second S-SSB, wherein the second S-SSB comprises a second SL-SS identifier indicating a discontinuation of S-SSB transmission by the first UE.

Aspect 12: The method of aspect 11, further comprising: participating in communication of a third S-SSB from a second synchronization source after the discontinuation of S-SSB transmission by the first UE.

Aspect 13: The method of aspect 12, wherein participating in the communication of the third S-SSB comprises receiving the third S-SSB from the second synchronization source or transmitting the third S-SSB from the second UE as the second synchronization source based at least in part on an S-SSB unavailability.

Aspect 14: The method of any of aspects 12 through 13, wherein the third S-SSB is received with the first SL-SS identifier based at least in part on a reception, in an occasion, of the first S-SSB comprising the first SL-SS identifier and the second S-SSB comprising the second S-SSB.

Aspect 15: A method for wireless communications at a first UE, comprising: receiving, from a second UE, an indication of a second S-SSB reception schedule with reduced S-SSB communication relative to a first S-SSB reception schedule; and transmitting a second S-SSB comprising a second SL-SS identifier associated with the second S-SSB reception schedule, wherein the second SL-SS identifier is different from a first SL-SS identifier associated with the first S-SSB reception schedule.

Aspect 16: The method of aspect 15, further comprising: transmitting, after the second S-SSB, sidelink paging SCI in a slot that is not included in the second S-SSB reception schedule, wherein the SCI indicates data to be transmitted to the second UE.

Aspect 17: The method of any of aspects 15 through 16, wherein the indication of the second S-SSB reception schedule indicates a reduced periodicity relative to a periodicity of the first S-SSB reception schedule or indicates a TDD pattern.

Aspect 18: The method of any of aspects 15 through 17, further comprising: transmitting an indication of a third S-SSB reception schedule, wherein the third S-SSB reception schedule is based at least in part on predicted data traffic for the second UE.

Aspect 19: A method for wireless communications at a second UE, comprising: transmitting, to a first UE, an indication of a second S-SSB reception schedule with reduced S-SSB communication relative to a first S-SSB reception schedule; and receiving a second S-SSB comprising a second SL-SS identifier associated with the second S-SSB reception schedule, wherein the second SL-SS identifier is different from a first SL-SS identifier associated with the first S-SSB reception schedule.

Aspect 20: The method of aspect 19, further comprising: receiving, after the second S-SSB, sidelink paging SCI in a slot that is not included in the second S-SSB reception schedule, wherein the SCI indicates data to be transmitted to the second UE.

Aspect 21: The method of any of aspects 19 through 20, wherein the indication of the second S-SSB reception schedule indicates a reduced periodicity relative to a periodicity of the first S-SSB reception schedule or indicates a TDD pattern.

Aspect 22: The method of any of aspects 19 through 21, wherein the indication of the second S-SSB reception schedule is communicated via one or more RRC messages or via one or more MAC-CE messages via a sidelink.

Aspect 23: The method of any of aspects 19 through 22, wherein resources of the second S-SSB reception schedule are associated with one or more spatial filters, the one or more spatial filters are quasi-co-located with one or more transmit beams of the first UE.

Aspect 24: The method of any of aspects 19 through 23, further comprising: receiving an indication of a third S-SSB reception schedule, wherein the third S-SSB reception schedule is based at least in part on predicted data traffic for the second UE.

Aspect 25: The method of any of aspects 19 through 24, further comprising: receiving an indication of a reception pattern, wherein the second UE activates a receiver for a combination of the second S-SSB reception schedule and the reception pattern.

Aspect 26: The method of any of aspects 19 through 25, further comprising: receiving an indication rejecting the second S-SSB reception schedule; and entering a DRX state in response to the indication.

Aspect 27: A first UE for wireless communications, comprising one or more memories storing processor-executable code, and one or more processors coupled with the one or more memories and individually or collectively operable to execute the code to cause the first UE to perform a method of any of aspects 1 through 10.

Aspect 28: A first UE for wireless communications, comprising at least one means for performing a method of any of aspects 1 through 10.

Aspect 29: A non-transitory computer-readable medium storing code for wireless communications, the code comprising instructions executable by one or more processors to perform a method of any of aspects 1 through 10.

Aspect 30: A second UE for wireless communications, comprising one or more memories storing processor-executable code, and one or more processors coupled with the one or more memories and individually or collectively operable to execute the code to cause the second UE to perform a method of any of aspects 11 through 14.

Aspect 31: A second UE for wireless communications, comprising at least one means for performing a method of any of aspects 11 through 14.

Aspect 32: A non-transitory computer-readable medium storing code for wireless communications, the code comprising instructions executable by one or more processors to perform a method of any of aspects 11 through 14.

Aspect 33: A first UE for wireless communications, comprising one or more memories storing processor-executable code, and one or more processors coupled with the one or more memories and individually or collectively operable to execute the code to cause the first UE to perform a method of any of aspects 15 through 18.

Aspect 34: A first UE for wireless communications, comprising at least one means for performing a method of any of aspects 15 through 18.

Aspect 35: A non-transitory computer-readable medium storing code for wireless communications, the code comprising instructions executable by one or more processors to perform a method of any of aspects 15 through 18.

Aspect 36: A second UE for wireless communications, comprising one or more memories storing processor-executable code, and one or more processors coupled with the one or more memories and individually or collectively operable to execute the code to cause the second UE to perform a method of any of aspects 19 through 26.

Aspect 37: A second UE for wireless communications, comprising at least one means for performing a method of any of aspects 19 through 26.

Aspect 38: A non-transitory computer-readable medium storing code for wireless communications, the code comprising instructions executable by one or more processors to perform a method of any of aspects 19 through 26.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first user equipment (UE), comprising:
one or more memories storing processor-executable code; and
one or more processors coupled with the one or more memories and individually or collectively operable to execute the code to cause the first UE to:
transmit a first sidelink synchronization signal block (S-SSB) from the first UE as a first synchronization source, wherein the first S-SSB comprises a first sidelink synchronization signal (SL-SS) identifier; and
transmit a second S-SSB, wherein the second S-SSB comprises a second SL-SS identifier indicating a discontinuation of S-SSB transmission by the first UE.

2. The first UE of claim 1, wherein the one or more processors are individually or collectively further operable to execute the code to cause the first UE to:
receive configuration information indicating the second SL-SS identifier for indicating the discontinuation of S-SSB transmission by the first UE.

3. The first UE of claim 1, wherein the second SL-SS identifier for indicating the discontinuation of S-SSB transmission by the first UE is selected from a set of SL-SS identifiers.

4. The first UE of claim 1, wherein the second SL-SS identifier for indicating the discontinuation of S-SSB transmission by the first UE is based at least in part on the first SL-SS identifier associated with the first S-SSB from the first UE as the first synchronization source.

5. The first UE of claim 1, wherein the second S-SSB comprising the second SL-SS identifier for indicating the discontinuation of S-SSB transmission by the first UE is transmitted on a same resource in a frequency domain as the first S-SSB.

6. The first UE of claim 1, wherein the one or more processors are individually or collectively further operable to execute the code to cause the first UE to:
enter a sidelink discontinuous reception (SL DRX) state associated with the discontinuation of S-SSB transmission by the first UE; and
enter an awake state after the SL DRX state, wherein the first UE synchronizes with another UE based at least in part on another S-SSB or resumes S-SSB transmission based at least in part on an S-SSB unavailability.

7. The first UE of claim 1, wherein:
the first S-SSB is associated with a first power conservation regime that consumes less power than a second power conservation regime, and
the second S-SSB comprising the second SL-SS identifier indicating the discontinuation of S-SSB transmission by the first UE is associated with the first power conservation regime.

8. The first UE of claim 1, wherein the one or more processors are individually or collectively further operable to execute the code to cause the first UE to:
receive a third S-SSB from a second synchronization source after the discontinuation of S-SSB transmission by the first UE.

9. A first user equipment (UE), comprising:
one or more memories storing processor-executable code; and
one or more processors coupled with the one or more memories and individually or collectively operable to execute the code to cause the first UE to:
receive, from a second UE, an indication of a second sidelink synchronization signal block (S-SSB) reception schedule with reduced S-SSB communication relative to a first S-SSB reception schedule; and
transmit a second S-SSB comprising a second sidelink synchronization signal (SL-SS) identifier associated with the second S-SSB reception schedule, wherein the second SL-SS identifier is different from a first SL-SS identifier associated with the first S-SSB reception schedule.

10. The first UE of claim 9, wherein the one or more processors are individually or collectively further operable to execute the code to cause the first UE to:
transmit, after the second S-SSB, sidelink paging sidelink control information (SCI) in a slot that is not included in the second S-SSB reception schedule, wherein the SCI indicates data to be transmitted to the second UE.

11. The first UE of claim 9, wherein the indication of the second S-SSB reception schedule indicates a reduced periodicity relative to a periodicity of the first S-SSB reception schedule or indicates a time-division duplexing (TDD) pattern.

12. The first UE of claim 9, wherein the one or more processors are individually or collectively further operable to execute the code to cause the first UE to:
transmit an indication of a third S-SSB reception schedule, wherein the third S-SSB reception schedule is based at least in part on predicted data traffic for the second UE.

13. A second user equipment (UE), comprising:
one or more memories storing processor-executable code; and
one or more processors coupled with the one or more memories and individually or collectively operable to execute the code to cause the second UE to:
transmit, to a first UE, an indication of a second sidelink synchronization signal block (S-SSB) reception schedule with reduced S-SSB communication relative to a first S-SSB reception schedule; and
receive a second S-SSB comprising a second sidelink synchronization signal (SL-SS) identifier associated with the second S-SSB reception schedule, wherein the second SL-SS identifier is different from a first SL-SS identifier associated with the first S-SSB reception schedule.

14. The second UE of claim 13, wherein the one or more processors are individually or collectively further operable to execute the code to cause the second UE to:
receive, after the second S-SSB, sidelink paging sidelink control information (SCI) in a slot that is not included in the second S-SSB reception schedule, wherein the SCI indicates data to be transmitted to the second UE.

15. The second UE of claim 13, wherein the indication of the second S-SSB reception schedule indicates a reduced periodicity relative to a periodicity of the first S-SSB reception schedule or indicates a time-division duplexing (TDD) pattern.

16. The second UE of claim 13, wherein the indication of the second S-SSB reception schedule is communicated via one or more radio resource control (RRC) messages or via one or more media access control-control element (MAC-CE) messages via a sidelink.

17. The second UE of claim 13, wherein:
resources of the second S-SSB reception schedule are associated with one or more spatial filters, and
the one or more spatial filters are quasi-co-located with one or more transmit beams of the first UE.

18. The second UE of claim 13, wherein the one or more processors are individually or collectively further operable to execute the code to cause the second UE to:
receive an indication of a third S-SSB reception schedule, wherein the third S-SSB reception schedule is based at least in part on predicted data traffic for the second UE.

19. The second UE of claim 13, wherein the one or more processors are individually or collectively further operable to execute the code to cause the second UE to:
receive an indication of a reception pattern, wherein the second UE activates a receiver for a combination of the second S-SSB reception schedule and the reception pattern.

20. The second UE of claim 13, wherein the one or more processors are individually or collectively further operable to execute the code to cause the second UE to:
receive an indication rejecting the second S-SSB reception schedule; and
enter a discontinuous reception (DRX) state in response to the indication.
